(19) United States
(12) Patent Application Publication
(10) Pub. No.: US 2025/0149066 A1
(43) Pub. Date: May 8, 2025

(54) VIDEO EDITING DEVICE AND OPERATION METHOD OF VIDEO EDITING DEVICE

(71) Applicant: LG ELECTRONICS INC., Seoul (KR)

(72) Inventors: Hwasoo WOO, Seoul (KR); Junwoo LEE, Seoul (KR); Jinsoo OH, Seoul (KR)

(73) Assignee: LG ELECTRONICS INC., Seoul (KR)

(21) Appl. No.: 18/292,761

(22) PCT Filed: Jul. 28, 2021
(86) PCT No.: PCT/KR2021/009761

§ 371 Date: Jan. 15, 2025

(51) Int. Cl. G11B 27/031; G06V 20/40

(52) U.S. Cl. CPC G11B 27/031; G06V 20/46

(57) ABSTRACT

The present disclosure provides a video editing device comprising: a communication unit which communicates with the outside; an input/output unit which receives a user input and outputs a video editing result; and a control unit, wherein the control unit: obtains a reference video and a target video; analyzes the features of the obtained reference video and the features of the obtained target video; edits the target video on the basis of the analyzed features of the reference video; and outputs the edited target video via the input/output unit.

### TECHNICAL FIELD

The present disclosure relates to a video editing device for editing an obtained video using a deep learning network and method of operating the same.

### BACKGROUND ART

Recent technology fields such as artificial intelligence, IoT, cloud computing, and big data are converging and pushing the world into the fourth industrial revolution.

Here, deep structured learning is referred to as deep learning, is defined as a set of machine learning algorithms that attempt high-level abstractions through a combination of various non-linear transformation techniques, and is considered to be one field of machine learning for teaching a computer how to think like human in a large frame.

When there is any data, it is represented in a form that a computer can understand (e.g., represent pixel information as a column vector in the case of an image) and applied to learning, and thus many studies (how to make better expression techniques and how to make models to learn them) are being conducted. As a result of these efforts, various deep learning techniques such as Deep Neural Networks (DNN), Convolutional Deep Neural Networks (CNN), and Deep Belief Networks (DBN) have been applied to computer vision, voice recognition, natural language processing, and voice/signal processing, thereby showing state-of-the-art results.

Additionally, recently, in the “non-contact” era, the number of people aiming to become beginner creators has been increasing. In addition, it is common for general users who enjoy SNS to edit videos they have shot in order to share videos with others.

However, video editing requires specialized knowledge and an understanding of complex programs, and thus ordinary people without specialized knowledge do not have easy access to video editing in reality.

Therefore, there is a need for easy-to-use video editing technology that meets the user's intentions.

### DISCLOSURE

### Technical Tasks

The present disclosure is directed to address the above-described issues and others issues.

One technical task of the present disclosure is to edit a target video using a reference video analyzed through a deep learning network.

### Technical Solutions

In one aspect of the present disclosure, provided is a video editing device including a communication unit communicating externally, an input/output unit receiving a user input and outputting a video editing result, and a controller configured to obtain a reference video and a target video, analyze features of the obtained reference and target videos, respectively, edit the target video based on the analyzed features of the reference video, and output the edited target video through the input/output unit.

The analyzed features may include at least one of a scene change effect, a scene change length, a color filter, an angle of view, a composition, a video quality, a video BGM, a person detection, an object detection, an object classification, a background detection, a place detection, an in-video text, or a subject motion.

The controller may edit the target video based on at least one of a scene change effect, a scene change length, a color style, a motion blur, a resolution, a noise, a BGM, an angle of view, a composition, or a dynamic motion when editing the target video based on the analyzed features of the reference video.

The controller may analyze the features of the obtained reference video and the features of the obtained target video through a deep learning network, respectively, and edit the target video based on the analyzed features of the reference video.

The deep learning network may include a video analysis network and a video editing network and the controller may be configured to analyze the features of the obtained reference video and the features of the obtained target video through the video analysis network, respectively, and edit the target video through the video editing network.

The deep learning network may exist in an external server, the video editing device may be connected to the deep learning network through the communication unit, and the controller may be configured to transmit the obtained reference video and the obtained target video to the deep learning network and receive the edited target video from the deep learning network.

The controller may provide an auto-edit interface to the user.

The controller may be configured to receive inputs of the reference video and the target video from the user, edit the target video according to an editing request of the user, and save the edited target video according to a save request of the user with respect to the edited target video.

The controller may transmit the saved target video externally through the communication unit.

The controller may save the edited target video to a preset path (URL).

The controller may provide a manual-edit interface to the user with respect to the edited target video when receiving a signal for additional refinement from the user after the edited target video has been outputted.

The manual-edit interface may include at least one of a clip, a BGM insertion, a color change, a mosaic processing, or a caption addition.

The controller may receive feedback on the outputted target video from the user.

The video editing device may further include a memory, and the controller may save the edited target video to the memory.

In another aspect of the present disclosure, provided is a method of operating a video editing device, the method including obtaining a reference video and a target video, analyzing features of the obtained reference and target videos, respectively, editing the target video based on the analyzed features of the reference video, and outputting the edited target video.

### Advantageous Effects

The effects of the video editing device and method of operating the same according to the present disclosure will be described below.

According to at least one of the embodiments of the present disclosure, a video may be edited based on user's intention.

According to at least one of embodiments of the present disclosure, since a video is edited using a reference video, it is advantageous in that a video may be edited without professional technology.

According to at least one of the embodiments of the present disclosure, a user may be allowed to easily edit a video by applying existing editing functions.

Further scope of applicability of the present disclosure will become apparent from the following detailed description.

Various changes and modifications within the spirit and scope of the present disclosure will be apparent to those skilled in the art, and therefore the detailed description and specific embodiments, such as preferred embodiments of the present disclosure, should be understood to be given by way of example only.

### DESCRIPTION OF DRAWINGS

FIG. 1 is a block diagram to describe a video editing device related to the present disclosure.

FIG. 2 is a schematic diagram illustrating a video editing device and method of operating the same according to one embodiment of the present disclosure.

FIG. 3 is a diagram illustrating operations of a video editing device and a deep learning network according to one embodiment of the present disclosure.

FIG. 4 is a block diagram of a video editing device according to one embodiment of the present disclosure.

FIG. 5 is a flowchart illustrating a method of operating a video editing device according to one embodiment of the present disclosure.

FIG. 6 is a flowchart illustrating an operating method of a server according to one embodiment of the present disclosure.

FIG. 7 is a diagram illustrating an example in which a video editing device according to one embodiment of the present disclosure analyzes a video.

FIGS. 8A to 8C are diagrams illustrating a detailed embodiment in which a video editing device according to one embodiment of the present disclosure analyzes a video.

FIG. 9 is a diagram illustrating an example of performing face recognition within a video in a video editing device according to one embodiment of the present disclosure.

FIG. 10 is a diagram illustrating an example of performing object and place recognition within a video in a video editing device according to one embodiment of the present disclosure.

FIG. 11 is a diagram illustrating an example of tracking an object recognized within a video in a video editing device according to one embodiment of the present disclosure.

FIG. 12 is a diagram illustrating an example of detecting a scene change within a video in a video editing device according to one embodiment of the present disclosure.

FIG. 13 is a diagram illustrating an example of changing a color style within a video in a video editing device according to one embodiment of the present disclosure.

FIG. 14 is a diagram illustrating an example of recognizing a BGM within a video in a video editing device according to one embodiment of the present disclosure.

FIG. 15 is a diagram illustrating an example of performing text recognition within a video in a video editing device according to one embodiment of the present disclosure.

FIG. 16 is a diagram illustrating an example of obtaining a reference video by a video editing device according to one embodiment of the present disclosure.

FIG. 17 is a diagram illustrating an example of obtaining a target video by a video editing device according to one embodiment of the present disclosure.

FIG. 18 is a diagram illustrating an example of analyzing a reference video and a target video by a video editing device according to one embodiment of the present disclosure.

FIG. 19 is a diagram illustrating an example in which a reference video and a target video are analyzed according to one embodiment of the present disclosure.

FIG. 20 is a diagram illustrating an example of storing a target video by a video editing device according to one embodiment of the present disclosure.

FIG. 21 is a diagram illustrating an example of clipping a video in a manual-edit interface provided by a video editing device according to one embodiment of the present disclosure.

FIG. 22 is a diagram illustrating an example of changing a BGM of a video in a manual-edit interface provided by a video editing device according to one embodiment of the present disclosure.

FIG. 23 is a diagram illustrating an example of changing a color of a video in a manual-edit interface provided by a video editing device according to one embodiment of the present disclosure.

FIG. 24 is a diagram illustrating an example of performing mosaic processing on a video in a manual-edit interface provided by a video editing device according to one embodiment of the present disclosure.

FIG. 25 is a diagram illustrating an example of adding a caption in a manual-edit interface provided by a video editing device according to one embodiment of the present disclosure.

FIG. 26 is a diagram illustrating an example of storing a target video in a manual-edit interface provided by a video editing device according to one embodiment of the present disclosure.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Artificial Intelligence (AI) refers to a field that studies artificial intelligence or methodology capable of achieving artificial intelligence. Machine learning refers to a field that defines various problems handled in the AI field and studies methodology for solving the problems.

In addition, AI does not exist on its own, but is rather directly or indirectly related to other fields in computer science. In recent years, there have been numerous attempts to introduce an AI element into various fields of information technology to use AI to solve problems in those fields.

Machine learning is an area of Al including the field of study that assigns the capability to learn to a computer without being explicitly programmed.

Specifically, machine learning may be a technology for researching and constructing a system for learning based on empirical data, performing prediction, and improving its own performance and researching and constructing an algorithm for the system. Algorithms of machine learning take a method of constructing a specific model in order to derive prediction or determination based on input data, rather than performing strictly defined static program instructions.

The term machine learning may be used interchangeably with the term machine learning.

Numerous machine learning algorithms have been developed in relation to how to classify data in machine learning. Representative examples of such machine learning algorithms include a decision tree, a Bayesian network, a support vector machine (SVM), and an artificial neural network (ANN).

The decision tree refers to an analysis method that plots decision rules on a tree-like graph to perform classification and prediction.

The Bayesian network is a model that represents the probabilistic relationship (conditional independence) between a plurality of variables in a graph structure. The Bayesian network is suitable for data mining through unsupervised learning.

The SVM is a supervised learning model for pattern recognition and data analysis, mainly used in classification and regression analysis.

The ANN is a data processing system in which a plurality of neurons, referred to as nodes or processing elements, is interconnected in layers, as a model of the interconnection relationship between the operation principle of biological neurons and neurons.

The ANN is a model used in machine learning and includes a statistical learning algorithm inspired by a biological neural network (particularly, the brain in the central nervous system of an animal) in machine learning and cognitive science.

Specifically, the ANN may mean a model having a problem-solving ability by changing the strength of connection of synapses through learning at artificial neurons (nodes) forming a network by connecting synapses.

The term ANN may be used interchangeably with the term neural network.

The ANN may include a plurality of layers, each including a plurality of neurons. In addition, the ANN may include synapses connecting neurons.

The ANN may be generally defined by the following three factors: (1) a connection pattern between neurons of different layers: (2) a learning process that updates the weight of a connection: and (3) an activation function for generating an output value from a weighted sum of inputs received from a previous layer.

The ANN includes, without being limited to, network models such as a deep neural network (DNN), a recurrent neural network (RNN), a bidirectional recurrent deep neural network (BRDNN), a multilayer perceptron (MLP), and a convolutional neural network (CNN).

The term “layer” may be used interchangeably with the term “tier” in this specification.

The ANN is classified as a single-layer neural network or a multilayer neural network according to the number of layers.

A general single-layer neural network includes an input layer and an output layer.

In addition, a general multilayer neural network includes an input layer, one or more hidden layers, and an output layer.

The input layer is a layer that accepts external data. The number of neurons of the input layer is equal to the number of input variables. The hidden layer is disposed between the input layer and the output layer. The hidden layer receives a signal from the input layer and extract features. The hidden layer transfers the features to the output layer. The output layer receives a signal from the hidden layer and outputs an output value based on the received signal. Input signals of neurons are multiplied by respective strengths (weights) of connection and then are summed. If the sum is larger than a threshold of the neuron, the neuron is activated to output an output value obtained through an activation function.

The DNN including a plurality of hidden layers between an input layer and an output layer may be a representative ANN for implementing deep learning which is machine learning technology.

The present disclosure may employ the term “deep learning.”

The ANN may be trained using training data. Herein, training may mean a process of determining parameters of the ANN using training data for the purpose of classifying, regressing, or clustering input data. Representative examples of the parameters of the ANN may include a weight assigned to a synapse or a bias applied to a neuron.

The ANN trained by the training data may classify or cluster input data according to the pattern of the input data.

Meanwhile, the ANN trained using the training data may be referred to as a trained model in the present specification.

Next, a learning method of the ANN will be described.

The learning method of the ANN may be broadly classified into supervised learning, unsupervised learning, semi-supervised learning, and reinforcement learning.

Supervised learning is a method of the machine learning for deriving one function from the training data. Among derived functions, outputting consecutive values may be referred to as regression, and predicting and outputting a class of an input vector may be referred to as classification.

In supervised learning, the ANN is trained in a state in which a label for the training data has been given. Here, the label may refer to a correct answer (or a result value) to be inferred by the ANN when the training data is input to the ANN.

Throughout the present specification, the correct answer (or result value) to be inferred by the ANN when the training data is input is referred to as a label or labeling data.

In the present specification, labeling the training data for training the ANN is referred to as labeling the training data with labeling data. In this case, the training data and a label corresponding to the training data may configure one training set and may be input to the ANN in the form of the training set.

Meanwhile, the training data represents a plurality of features, and labeling the training data may mean labeling the feature represented by the training data. In this case, the training data may represent the feature of an input object in the form of a vector.

The ANN may derive a function of an association between the training data and the labeling data using the training data and the labeling data. Then, the ANN may determine (optimize) the parameter thereof by evaluating the derived function.

Unsupervised learning is a kind of machine learning in which the training data is not labeled.

Specifically, unsupervised learning may be a learning method that trains the ANN to discover and classify a pattern in the training data itself rather than the association between the training data and the label corresponding to the training data.

Examples of unsupervised learning may include, but are not limited to, clustering and independent component analysis.

The present disclosure may employ the term “clustering.”

Examples of the ANN using unsupervised learning include, but are not limited to, a generative adversarial network (GAN) and an autoencoder (AE).

The GAN is a machine learning method of improving performance through competition between two different AI models, i.e., a generator and a discriminator.

In this case, the generator is a model for generating new data and may generate new data based on original data.

The discriminator is a model for discriminating the pattern of data and may serve to discriminate whether input data is original data or new data generated by the generator.

The generator may receive and learn data that has failed to deceive the discriminator, while the discriminator may receive deceiving data from the generator and learn the data. Accordingly, the generator may evolve to maximally deceive the discriminator, while the discriminator may evolve to well discriminate between the original data and the data generated by the generator.

The AE is a neural network which aims to reproduce input itself as output.

The AE may include an input layer, at least one hidden layer, and an output layer. Since the number of nodes of the hidden layer is smaller than the number of nodes of the input layer, the dimensionality of data is reduced and thus compression or encoding is performed.

Furthermore, data output from the hidden layer is input to the output layer. In this case, since the number of nodes of the output layer is greater than the number of nodes of the hidden layer, the dimensionality of the data increases and thus decompression or decoding is performed.

Meanwhile, the AE controls the strength of connection of neurons through learning, such that input data is represented as hidden-layer data. In the hidden layer, information is represented by fewer neurons than neurons of the input layer, and reproducing input data as output may mean that the hidden layer finds a hidden pattern from the input data and expresses the hidden pattern.

Semi-supervised learning is a kind of machine learning that makes use of both labeled training data and unlabeled training data.

One semi-supervised learning technique involves inferring the label of unlabeled training data and then performing learning using the inferred label. This technique may be useful when labeling cost is high.

Reinforcement learning is a theory that an agent is capable of finding an optimal path based on experience without reference to data when an environment in which the agent may decide what action is taken every moment is given.

Reinforcement learning may be mainly performed by a Markov decision process (MDP).

The MDP will be briefly described. First, an environment including information necessary for the agent to take a subsequent action is given. Second, what action is taken by the agent in that environment is defined. Third, a reward given to the agent when the agent successfully takes a certain action and a penalty given to the agent when the agent fails to take a certain action are defined. Fourth, experience is repeated until a future reward is maximized, thereby deriving an optimal action policy.

The ANN may specify the structure thereof by a configuration, an activation function, a loss or cost function, a learning algorithm, and an optimization algorithm, of a model. Hyperparameters may be preconfigured before learning, and model parameters may then be configured through learning to specify the contents of the ANN.

For instance, the structure of the ANN may be determined by factors, including the number of hidden layers, the number of hidden nodes included in each hidden layer, an input feature vector, and a target feature vector.

The hyperparameters include various parameters which need to be initially configured for learning, such as initial values of the model parameters. The model parameters include various parameters to be determined through learning.

For example, the hyperparameters may include an initial value of a weight between nodes, an initial value of a bias between nodes, a mini-batch size, a learning iteration number, and a learning rate. Furthermore, the model parameters may include the weight between nodes and the bias between nodes.

The loss function may be used as an index (reference) for determining an optimal model parameter during a learning process of the ANN. Learning in the ANN may mean a process of manipulating model parameters so as to reduce the loss function, and the purpose of learning may be determining the model parameters that minimize the loss function.

The loss function may typically use a means squared error (MSE) or cross-entropy error (CEE), but the present disclosure is not limited thereto.

The CEE may be used when a correct answer label is one-hot encoded. One-hot encoding is an encoding method in which only for neurons corresponding to a correct answer, a correct answer label value is set to be 1 and, for neurons that do not correspond to the correct answer, the correct answer label value is set to be 0.

Machine learning or deep learning may use a learning optimization algorithm to minimize the loss function. Examples of the learning optimization algorithm include gradient descent (GD), stochastic gradient descent (SGD), momentum, Nesterov accelerate gradient (NAG), AdaGrad, AdaDelta, RMSProp, Adam, and Nadam.

GD is a method that adjusts the model parameters in a direction that reduces a loss function value in consideration of the slope of the loss function in a current state.

The direction in which the model parameters are adjusted is referred to as a step direction, and a size by which the model parameters are adjusted is referred to as a step size.

Here, the step size may mean a learning rate.

GD may obtain a slope of the loss function through partial derivative using each of the model parameters and update the model parameters by adjusting the model parameters by the learning rate in the direction of the obtained slope.

SGD is a method that separates training data into mini batches and increases the frequency of GD by performing GD for each mini batch.

AdaGrad, AdaDelta, and RMSProp are methods that increase optimization accuracy in SGD by adjusting the step size. Momentum and NAG are methods that increase optimization accuracy in SGD by adjusting the step direction. Adam is a method that combines momentum and RMSProp and increases optimization accuracy by adjusting the step size and the step direction. Nadam is a method that combines NAG and RMSProp and increases optimization accuracy by adjusting the step size and the step direction.

The learning rate and accuracy of the ANN greatly rely not only on the structure and learning optimization algorithms of the ANN but also on the hyperparameters. Therefore, in order to obtain a good learning model, it is important to configure a proper hyperparameter as well as determining a proper structure and learning algorithm of the ANN.

In general, the ANN is trained by experimentally configuring the hyperparameters as various values, and an optimal hyperparameter that provides a stable learning rate and accuracy as a result of learning is configured.

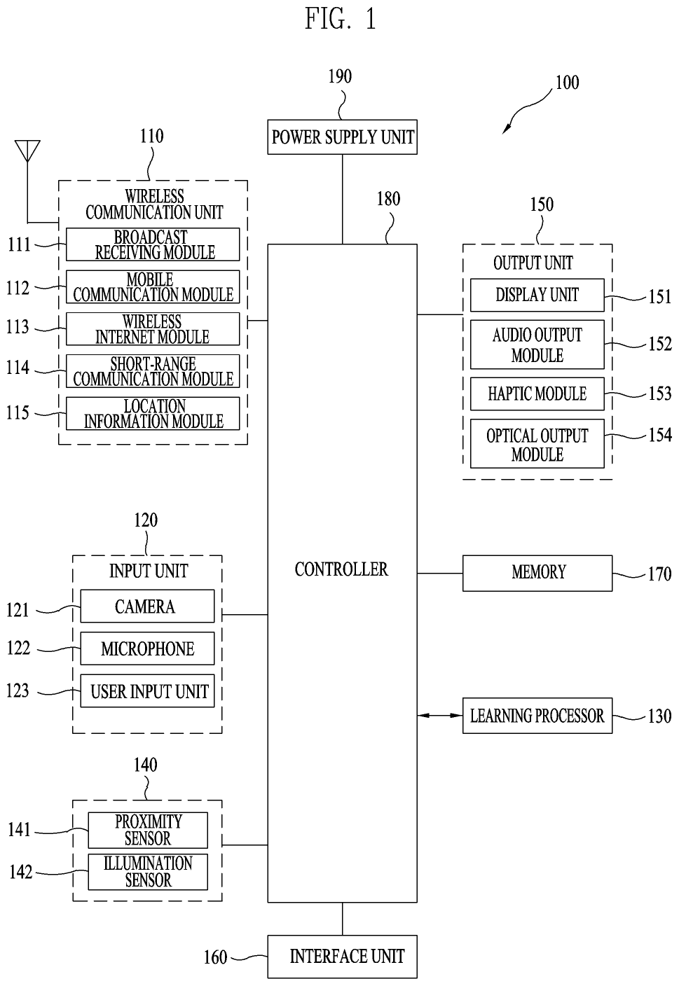

FIG. 1 is a block diagram illustrating a video editing device related to the present disclosure.

A video editing device 100 may be implemented as a fixed or mobile device such as a cell phone, a projector, a mobile phone, a smartphone, a laptop computer, a digital broadcasting terminal, a personal digital assistant (PDA), a portable multimedia player (PMP), a navigation device, a slate PC, a tablet PC, an ultrabook, a wearable device (e.g., a smartwatch, smart glasses, a head mounted display (HMD)), a set-top box (STB), a DMB receiver, a radio, a washing machine, a refrigerator, a desktop computer, or a digital signage.

In other words, the video editing device 100 may be implemented in various forms of household appliances, and may be applied to a fixed or mobile robot.

The video editing device 100 may perform the functions of a voice agent. The voice agent may be a program that recognizes a user's speech and outputs sound corresponding to a response appropriate to the recognized user's voice.

The video editing device 100 may include a wireless communication unit 110. an input unit 120, a learning processor 130, a sensing unit 140, an output unit 150, an interface unit 160, a memory 170, a controller 180, and a power supply unit 190. The components illustrated in FIG. 1 are not essential to implement the video editing device. The video editing device described herein may have more or fewer components than those listed above.

A trained model may be embedded on the video editing device 100.

The trained model may be implemented in hardware, software, or a combination of hardware and software. When a part or the entirety of the trained model is implemented in software, one or more instructions constituting the trained model may be stored in the memory 170.

The wireless communication unit 110 typically includes one or more modules which permit communications such as wireless communications between the video editing device 100 and a wireless communication system, communications between the video editing device 100 and another video editing device, communications between the video editing device 100 and an external server. Further, the wireless communication unit 110 typically includes one or more modules which connect the video editing device 100 to one or more networks.

To facilitate such communications, the wireless communication unit 110 includes one or more of a broadcast receiving module 111, a mobile communication module 112, a wireless Internet module 113, a short-range communication module 114, and a location information module 115.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the video editing device 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WibroWiBro), Worldwide Interoperability for Microwave Access (WimaxWiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the video editing device 100 and a wireless communication system, communications between the video editing device 100 and another video editing device 100, or communications between the video editing device and a network where another video editing device 100 (or an external server) is located, via wireless personal area networks. One example of the wireless area networks is a wireless personal area networks.

The location information module 115 is generally configured to detect, calculate, derive or otherwise identify a position of the video editing device. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the video editing device.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the video editing device 100. As another example, the cameras 121 may be located in a stereoscopic arrangement to acquire left and right images for implementing a stereoscopic image.

The microphone 122 is generally implemented to permit audio input to the video editing device 100. The audio input can be processed in various manners according to a function being executed in the video editing device 100. If desired, the microphone 122 may include assorted noise cancelling algorithms to remove unwanted noise generated in the course of receiving the external audio.

The user input unit 123 is a component that permits input by a user. Such user input may enable the controller 180 to control operation of the video editing device 100. The user input unit 123 may include one or more of a mechanical input element (for example, a key, a button located on a front and/or rear surface or a side surface of the video editing device 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the video editing device at a location that is other than the touch screen. On the other hand, the virtual key or the visual key may be displayed on the touch screen in various shapes, for example, graphic, text, icon, video, or a combination thereof.

The learning processor 130 learns a model configured as an artificial neural network based on training data.

Specifically, the learning processor 130 may determine optimized model parameters of the artificial neural network by iteratively training the artificial neural network using various learning techniques described above.

In the present disclosure, an artificial neural network whose parameters are determined by training based on the training data may be referred to as a trained model.

The trained model may be used to infer an output value for new input data other than the training data.

The learning processor 130 may be configured to receive, classify, store, and output information to be utilized for data mining, data analysis, intelligent decision making, and machine learning algorithms and techniques.

The learning processor 130 may include one or more memory units configured to store data that is received, detected, sensed, generated, predefined, or output by another component, device, terminal, or device in communication with the terminal.

The learning processor 130 may include a memory integrated or implemented in the terminal. In some embodiments, the learning processor 130 may be implemented using the memory 170.

Optionally or additionally, the learning processor 130 may be implemented using a memory related to the terminal, such as an external memory directly coupled to the terminal or a memory maintained on a server communicating with the terminal.

In other embodiments, the learning processor 130 may be implemented using a memory maintained in a cloud computing environment, or another remote memory location accessible by the terminal using a communication method such as a network.

The learning processor 130 may be generally configured to store data in one or more databases to identify, index, categorize, manipulate, store, retrieve, and output data for use in supervised or unsupervised learning, data mining, predictive analytics, or other machines. Here, the databases may be implemented using the memory 170, the memory 230 of the learning device 200, a memory maintained in a cloud computing environment, or another remote memory location accessible by the terminal through a communication method such as a network.

The information stored in the learning processor 130 may be utilized by the controller 180 or one or more other controllers of the terminal using any of a variety of different types of data analysis algorithms and machine learning algorithms.

Examples of such algorithms include, but are not limited to, a k-nearest neighbors system, fuzzy logic (e.g., possibility theory), a neural network, a Boltzmann machine, vector quantization, a pulse neural network, a support vector machine, a maximum margin classifier, hill climbing, a inductive logic system, a Bayesian network, Petri net (e.g., a finite state machine, the Mealy machine, Moore finite state machine), a classifier tree (e.g., a perceptron tree, a support vector tree, a Markov tree, a decision tree forest, a random forest), a reading model and system, artificial fusion, sensor fusion, image fusion, reinforcement learning, augmented reality, pattern recognition, and automated planning.

The controller 180 may determine or predict at least one executable operation of the terminal based on information determined or generated using data analysis and machine learning algorithms. To this end, the controller 180 may request, retrieve, receive, or utilize data from the learning processor 130, and may control the terminal to execute a predicted operation or an operation determined to be desirable among the at least one executable operation.

The controller 180 may perform various functions that implement intelligent emulation (i.e., a knowledge-based system, a reasoning system, and a knowledge acquisition system). This may be applied to various types of systems (e.g., fuzzy logic systems), including adaptive systems, machine learning systems, and artificial neural networks.

The controller 180 may also include sub-modules that enable operations involving speech and natural language speech processing, such as an I/O processing module, an environmental conditions module, a speech to text (STT) processing module, a natural language processing module, a task flow processing module, and a service processing module.

Each of these sub-modules may have access to one or more systems or data and models, or a subset or superset thereof in the terminal. Further, each of the sub-modules may provide various functions, including vocabulary indexes, user data, task flow models, service models, and automatic speech recognition (ASR) systems.

In other embodiments, other aspects of the controller 180 or the terminal may be implemented with the sub-modules, systems, or data and models.

In some examples, based on data from the learning processor 130, the controller 180 may be configured to detect and recognize requirements based on contextual conditions or user intent expressed as user input or natural language input.

The controller 180 may actively derive and acquire information necessary to completely determine the requirements based on the contextual conditions or user intent. For example, controller 180 may actively derive the information necessary to determine the requirements by analyzing past data including historical input and output, pattern matching, unambiguous words, and input intent.

The controller 180 may determine a task flow for executing a function that responds to the requirements based on the contextual conditions or user intent.

The controller 180 may be configured to collect, sense, extract, detect, and/or receive signals or data used for data analysis and machine learning tasks via one or more sensing components on the terminal to gather information for processing and storage by the learning processor 130.

Collecting information may include sensing information by sensors, extracting information stored in the memory 170, or receiving information from another terminal, entity, or external storage device via communication means.

The controller 180 may collect usage history information from the terminal and store the same in the memory 170.

The controller 180 may use the stored usage history information and predictive modeling to determine the best match for execution of a particular function.

The controller 180 may receive or sense ambient environmental information or other information using the sensing unit 140.

The controller 180 may receive broadcast signals and/or broadcast-related information, wireless signals, and wireless data through the wireless communication unit 110.

The controller 180 may receive image information (or a corresponding signals). audio information (or a corresponding signal), data, or user input information from the input unit 120.

The controller 180 may collect the information in real time, process or classify the information (e.g., knowledge graph, command policy, personalized database, dialog engine, etc.), and store the processed information in the memory 170) or the learning processor 130.

When the operation of the terminal is determined based on the data analysis and machine learning algorithms and techniques, the controller 180 may control components of the terminal to execute the determined operation. Then, the controller 180 may control the terminal according to a control instruction to perform the determined operation.

When a particular operation is performed, the controller 180 may analyze historical information indicating the execution of the particular operation using the data analysis and machine learning algorithm and technique, and may update the previously learned information based on the analyzed information.

Thus, the controller 180, together with the learning processor 130, may improve the accuracy of the future performance of the data analysis and machine learning algorithm and technique based on the updated information.

The sensing unit 140 is typically implemented using one or more sensors configured to sense internal information of the video editing device, the surrounding environment of the video editing device, user information, and the like. For example, the sensing unit 140 is shown having a proximity sensor 141 and an illumination sensor 142. If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The video editing device 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the video editing device 100 and a user, as well as function as the user input unit 123 which provides an input interface between the video editing device 100 and the user.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the video editing device 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

An optical output module 154 can output a signal for indicating an event generation using light of a light source. Examples of events generated in the video editing device 100 may include message reception, call signal reception, a missed call, an alarm, a schedule notice, an email reception, information reception through an application, and the like.

The interface unit 160 serves as an interface for external devices to be connected with the video editing device 100. For example, the interface unit 160 can receive data transmitted from an external device, receive power to transfer to elements and components within the video editing device 100, or transmit internal data of the video editing device 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The memory 170 is typically implemented to store data to support various functions or features of the video editing device 100. For instance, the memory 170 may be configured to store application programs executed in the video editing device 100, data or instructions for operations of the video editing device 100, and the like. Some of these application programs may be downloaded from an external server via wireless communication. Other application programs may be installed within the video editing device 100 at time of manufacturing or shipping, which is typically the case for basic functions of the video editing device 100 (for example, receiving a call, placing a call, receiving a message, sending a message, and the like). It is common for application programs to be stored in the memory 170, installed in the video editing device 100, and executed by the controller 180 to perform an operation (or function) for the video editing device 100.

The controller 180 typically functions to control overall operation of the video editing device 100, in addition to the operations associated with the application programs.

The controller 180 may provide or process information or functions appropriate for a user by processing signals, data, information and the like, which are input or output by the various components depicted in FIG. 1, or activating application programs stored in the memory 170. As one example, the controller 180 controls some or all of the components according to the execution of an application program that have been stored in the memory 170.

The power supply unit 190 can be configured to receive external power or provide internal power in order to supply appropriate power required for operating elements and components included in the video editing device 100. The power supply unit 190 may include a battery, and the battery may be configured to be embedded in a device body, or configured to be detachable from the device body.

At least some of the above-described components may operate in cooperation with each other to implement the operation, control, or control method of the mobile terminal according to various embodiments described below. Furthermore, the operation, control, or control method of the mobile terminal may be implemented on the mobile device by driving at least one application stored in the memory 170.

Hereinafter, an apparatus and method for analyzing features of a reference video by using a deep learning network and editing a target video to have features similar to the analyzed features will be described in detail.

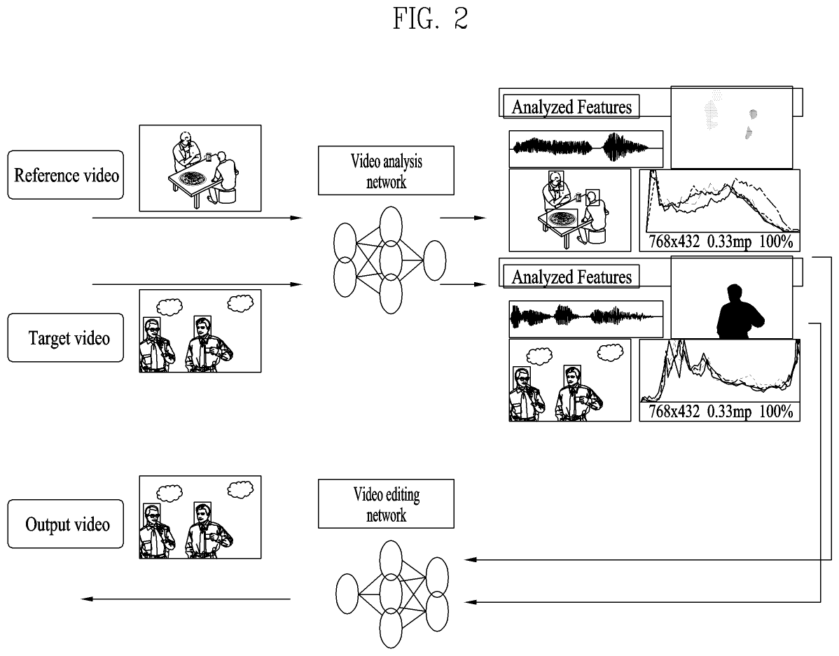

FIG. 2 is a schematic diagram illustrating a video editing device and method of operating the same according to one embodiment of the present disclosure.

Referring to FIG. 2, a video editing device may obtain a reference video and a target video, respectively. The video editing device may transmit the obtained reference video and the obtained target video to a video analysis network. Here, the video analysis network may correspond to one configuration of a deep learning network.

The video editing device may analyze features of the obtained reference video and the obtained target video based on the video analysis network. Here, the video may include both still and moving pictures. In this case, the video may be characterized in being a RAW MIDI file. In addition, features of a video may include image quality features of the video, such as composition, color, image quality, human, thing, background, and the like, and features of a captured subject.

The video editing device may transmit a feature of the analyzed reference video and a feature of the analyzed target video to the video editing network. Here, the video editing network may also correspond to one configuration of the deep learning network.

The video editing device may edit features of the target video by referring to features of the reference video through the video editing network. In this case, the video editing device may automatically or manually edit the features of the target video in response to a user's request.

The video editing device may output the edited target video through the output unit described above with reference to FIG. 1.

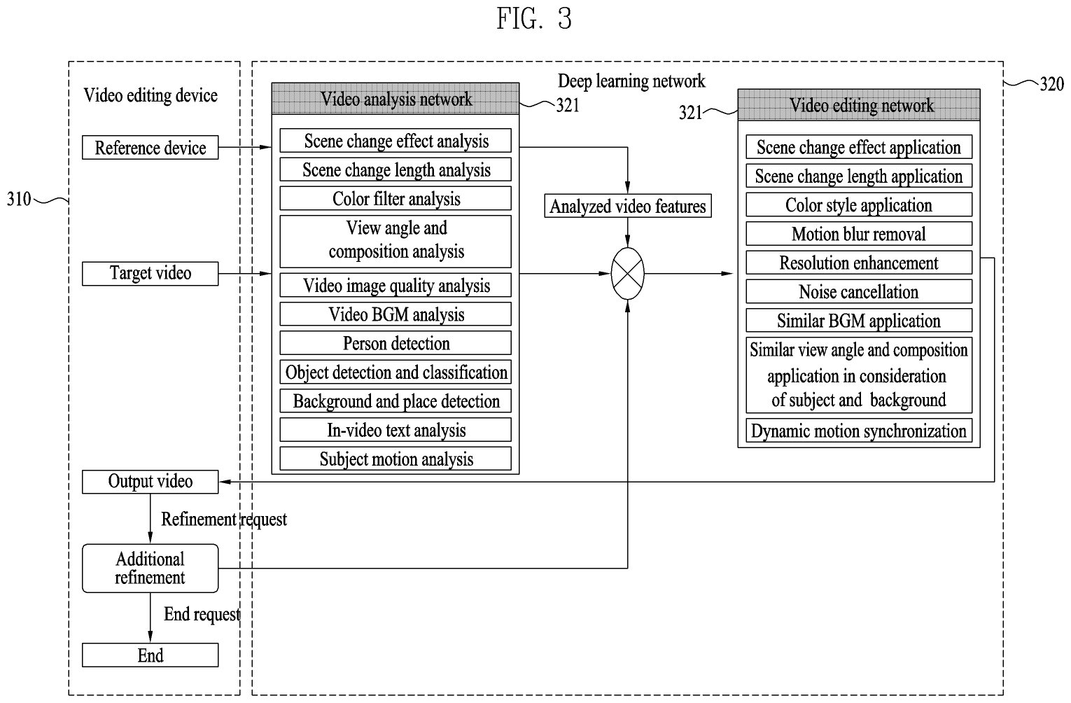

FIG. 3 is a diagram illustrating operations of a video editing device and a deep learning network according to one embodiment of the present disclosure.

In one embodiment of the present disclosure, a video editing device 310 may edit and output a video requested by a user (hereinafter, referred to as a target video) with reference to analyzed data. To this end, the video editing device 310 may require a pre-edited video or a reference video to be referred to by the target video.

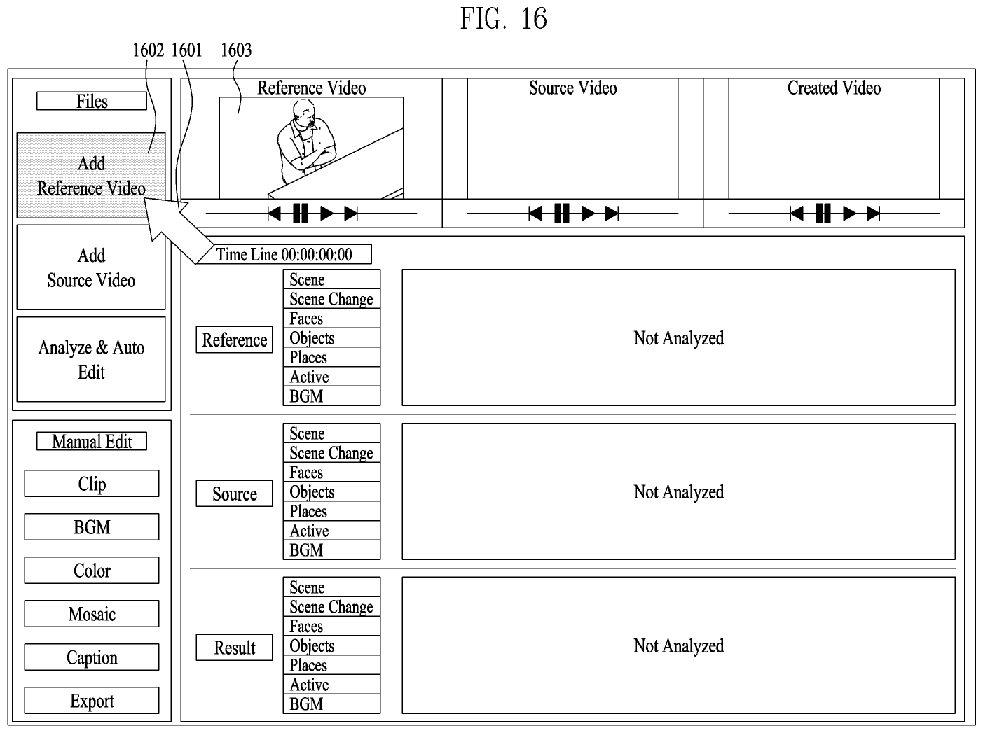

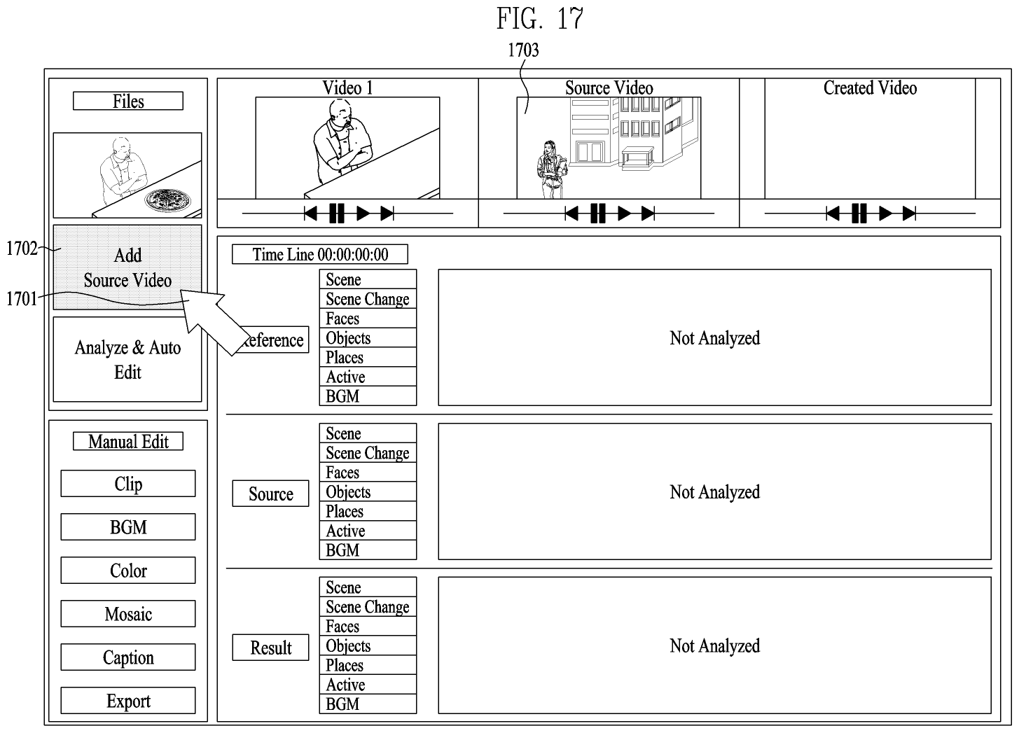

Referring to FIG. 3, the video editing device 310 may obtain a reference video and a target video. A method of obtaining the reference video and the target video will be described in detail with reference to FIG. 16 and FIG. 17.

The video editing device 310 may transmit the obtained reference video and the obtained target video to a deep learning network 320. In particular, in FIG. 3, the video editing device 310 and the deep learning network 320 are illustrated as being separate configuration, but a single video editing device 310 may include the deep learning network 320. That is, the deep learning network 320 may generally refer to a cloud server, but may be performed in the video editing device 310. However, for convenience of description, an embodiment in which the video editing device 310 and the deep learning network 320 are separated will be described.

In this case, the deep learning network 320 may include a video analysis network 321 and a video editing network 322.

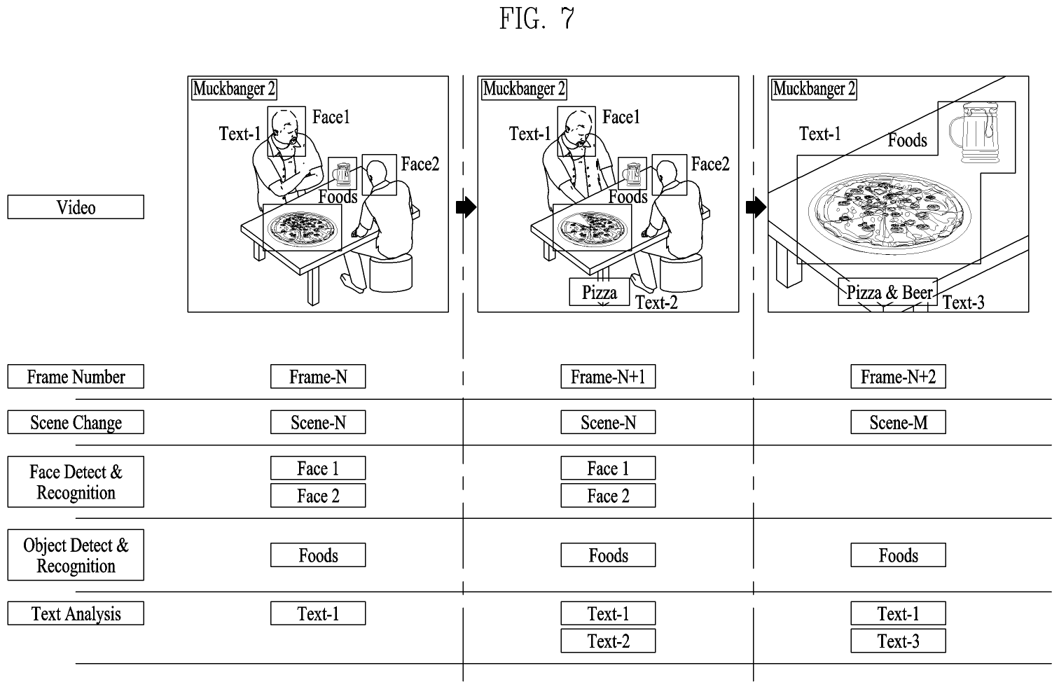

In one embodiment of the present disclosure, the deep learning network 320 may analyze features of the received reference and target videos through the video analysis network 321, respectively. More specifically, the video analysis network 321 may perform an scene change effect analysis, a scene change length analysis, a color filter analysis, a view angle and composition analysis, a video image quality analysis, a video BGM analysis, a person detection, an object detection and classification, a background and place detection, an in-video text analysis, a subject motion analysis and the like on each of the reference video and the target video. This will be described in detail with reference to FIGS. 7 to 15.

In addition, the deep learning network 320 may transmit the analyzed features of the reference video and the target video to the video editing network 322.

The video editing network 322 may edit the target video based on the received features of the reference video and the target video.

In one embodiment of the present disclosure, the video editing network 322 may edit the target video based on the analyzed features of the reference video. That is, the video editing network 322 may substitute at least one of the features of the reference video to the features of the target video automatically or based on a user request.

In one embodiment of the present disclosure, the video editing device 310 may edit the target video into a similar video by reflecting the features of the reference video as much as possible. Specifically, the video editing device 310 may reflect a story element such as a scene change, a compositional element such as motions of a main subject and a background, a style of background music, and the like.

More specifically, the features the video editing network 322 may apply to the target video are as follows. The video editing network 322 may apply a scene change effect application, a scene change length application, a color style application, a motion blur removal, a resolution enhancement, a noise cancellation, a similar BGM application, a similar view angle and composition application in consideration of a subject and a background, and a dynamic motion synchronization of the reference video to the target video. This will be described in detail with reference to the following drawings.

Thereafter, the video editing network 322 may transmit the edited target video to the video editing device 310.

The video editing device 310 may output the received target video, and may ask a user whether to make a final determination.

Thereafter, the video editing device 310 may receive a refinement request from the user.

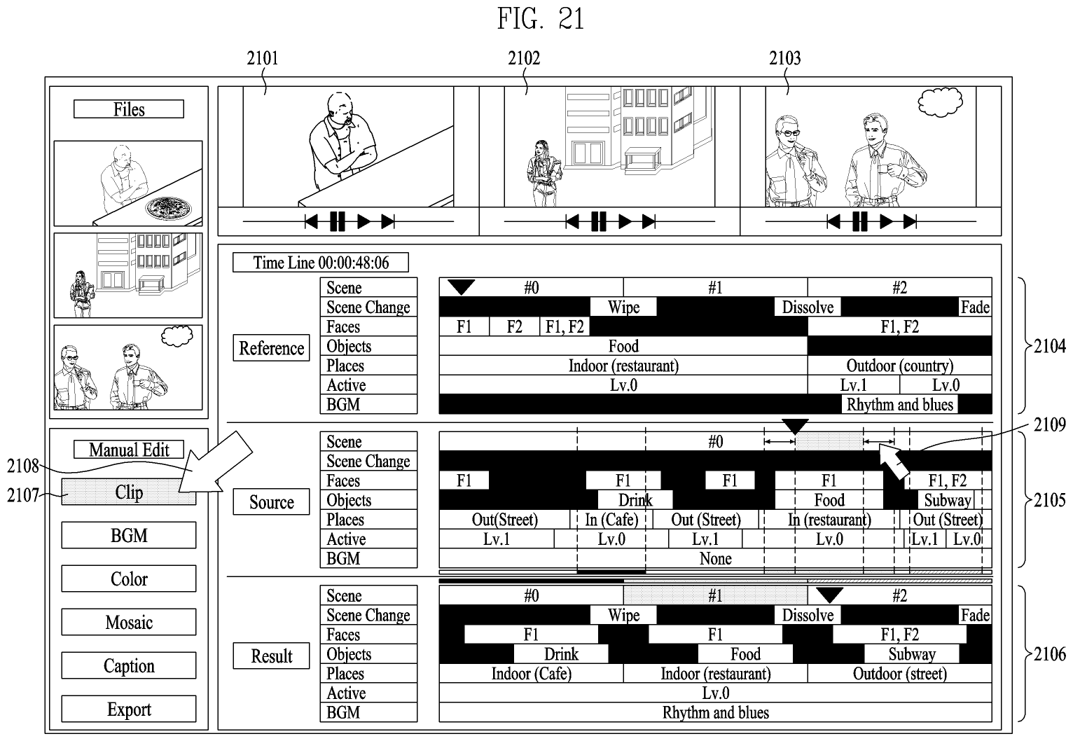

When the video editing device 310 receives the refinement request for the outputted target video, the video editing device 310 may further refine the target video. In doing so, the video editing device 310 may re-edit the automatically edited video through manual editing additionally. This will be described in detail with reference to FIGS. 21 to 26.

When there is no more refinement request for the outputted target video and an end request is received, the video editing device 310 may end the video editing and store or save the target video.

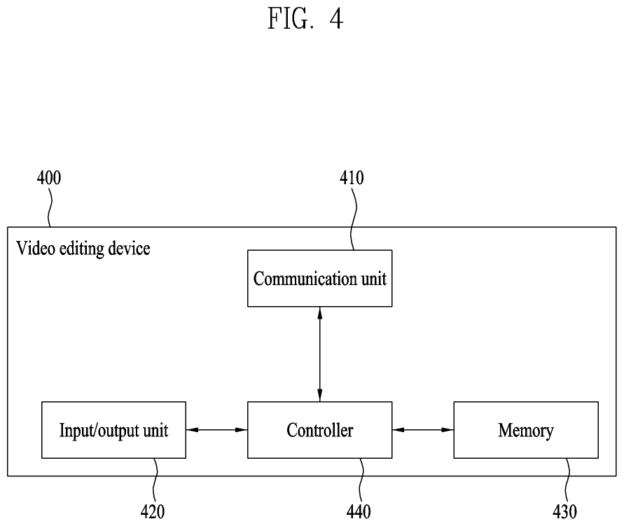

FIG. 4 is a block diagram of a video editing device according to one embodiment of the present disclosure.

Referring to FIG. 4, the video editing device 400 may include a communication unit 410, an input/output unit 420, a memory 430, and a controller 440. In this case, each component of the video editing device 400 may refer to the contents of the wireless communication unit, the input unit, the output unit, the memory, and the controller described above with reference to FIG. 1, and FIG. 4 only describes the features related to one embodiment of the present disclosure.

The communication unit 410 may transmit a reference video and a target video obtained by communicating externally to a deep learning network (not shown). In addition, the communication unit 410 may obtain a reference video and a target video from an external environment. That is, the communication unit 410 may receive not only a reference video and a target video stored in the video editing device 400, but also a reference video and a target video existing outside. In this case, the communication unit 410 may use a connection address (URL) of the reference video. In addition, the communication unit 410 may transmit an edited target video to the outside.

The input/output unit 420 includes an input unit and an output unit, receives an input signal from a user through a touchscreen, and outputs an edited target video through a display, etc. More specifically, the input/output unit 420 may receive a user's signal to obtain a reference video and a target video, and may receive a signal for automatic editing and manual editing of the target video. In addition, after the target video is completed, the input/output unit 420 may receive a signal regarding whether to additionally edit it and whether to store it.

The memory 430 may store the reference video, the target video, and the edited target video. In addition, the memory 430 may store information related to the analyzed features of the reference video and the target video. In addition, in one embodiment of the present disclosure, the memory 430) may store the analyzed features of the reference video. When editing of another target video is requested later, the memory 430 may enable the target video to be edited using the stored features without receiving a reference video.

The controller 440 may control the communicator 410, the input/output unit 420, and the memory 430 of the video editing device 400.

In one embodiment of the present disclosure, the controller 440 may obtain a reference video and a target video, and analyze features of the obtained reference video and the obtained target video, respectively. Here, the analyzed features may include at least one of a scene change effect, a scene change length, a color filter, an angle of view, a composition, a video quality, a video BGM, a person detection, an object detection, an object classification, a background detection, a place detection, an in-video text, and a subject motion.

In addition, the controller 440 may edit the target video based on the analyzed features of the reference video. More specifically, when editing the target video based on the analyzed features of the reference video, the controller 440 may edit the target video based on at least one of a scene change effect, a scene change length, a color style, a motion blur, a resolution, a noise, a BGM, an angle of view, a composition, and a dynamic motion.

In particular, the controller 440 may analyze the features of the obtained reference and target videos through the deep learning network, respectively and edit the target video based on the analyzed features of the reference video. In this case, the deep learning network may include a video analysis network and a video editing network, and the controller 440 may analyze features of the obtained reference and target videos through the video analysis network, and may edit the target video through the video editing network.

Thereafter, the controller 440 may provide an auto-edit interface to a user, and receive an input of a reference video and a target video from the user through the provided auto-edit interface. In addition, the controller 440 may edit the target video in response to an editing request made by the user through the auto-edit interface. In addition, the controller 440 may save the edited target video in response to a user's storage request through the auto-edit interface. In this case, the controller 440 may save the edited target video to a preset path (URL).

Thereafter, the controller 440 may output the edited target video.

In addition, when a signal for additional refinement is received from the user after the edited target video is output, the controller 440 may provide a manual-edit interface to the user with respect to the edited target video. Here, the manual-edit interface may include at least one of clip, BGM insertion, color change, mosaic processing, and caption addition.

In addition, the controller 440 may receive feedback on the outputted target video from the user.

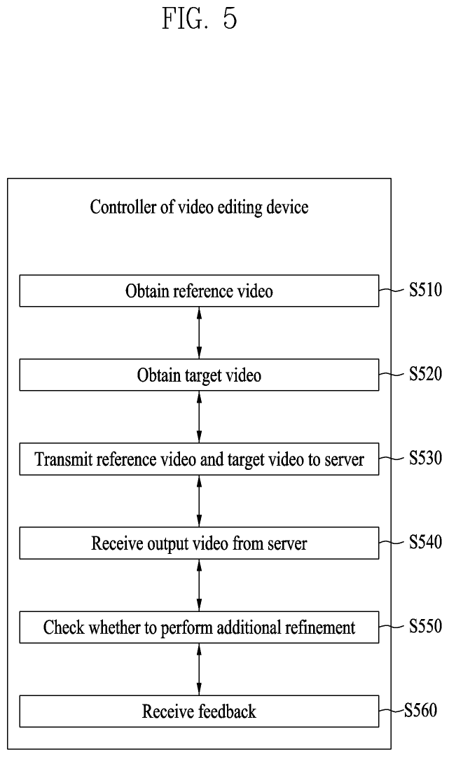

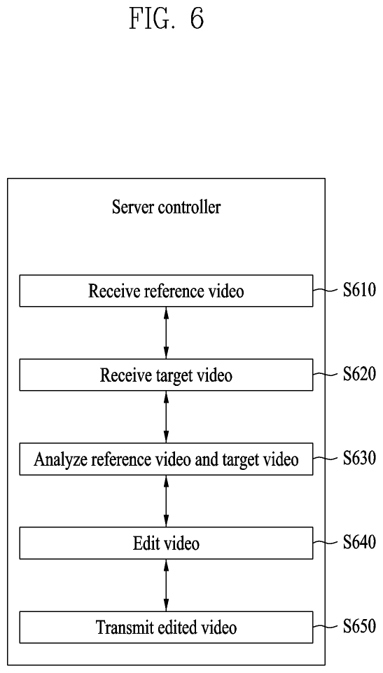

Hereinafter, operations performed by the controller of the video editing device and the controller of the server, described above with reference to FIG. 2 and FIG. 3, will be described with reference to FIGS. 5 and FIG. 6, respectively.

FIG. 5 is a flowchart illustrating a method of operating a video editing device according to one embodiment of the present disclosure. Hereinafter, although an operation is performed by a controller of the video editing device, it will be described as performed by the video editing device for convenience of description.

Referring to FIG. 5, in a step S510, a video editing device may obtain a reference video. In this case, instead of obtaining a direct file for the reference video, the video editing device may obtain a predetermined path (URL) for the reference video.

In a step S520, the video editing device may obtain a target video.

In a step S530, the video editing device may transmit the obtained reference and target videos to a server.

In a step S540, the video editing device may receive an edited video from the server. In this case, the server may analyze features of the received reference and target videos, and may edit the target video based on the analyzed features of the reference video.

In a step S550, the video editing device may determine whether to perform additional refinement from a user. In this case, the video editing device may output the edited target video to the user and then check whether the user intends to have the additional refinement performed. When receiving a signal for additional refinement from the user, the video editing device may re-edit the edited target video. When receiving a signal for an end request, the video editing device may save the edited target video.

In a step S560, the video editing device may receive feedback from the user.

FIG. 6 is a flowchart illustrating a method of operating a server according to one embodiment of the present disclosure. Hereinafter, although an operation is performed by a controller of the server, it will be described as performed by the server for convenience of description.

Referring to FIG. 6, in a step S610, a server may receive a reference video from a video editing device. In this case, the server may receive a path (URL) corresponding to the reference video from the video editing device.

In a step S620, the server may receive a target video from the video editing device.

In a step S630, the server may analyze features of the reference and target videos. The server may analyze features of the reference and target videos through a deep learning-based video analysis network.

In a step S640, the server may edit the target video based on the analyzed features of the reference video. The server may edit the target video based on the analyzed features of the reference video through the deep learning-based video editing network.

In a step S650, the server may transmit the edited video to the video editing device.

Hereinafter, a detailed embodiment of analyzing and editing a reference video and a target video will be described.

FIG. 7 is a diagram illustrating an example in which a video editing device analyzes a video according to one embodiment of the present disclosure.

Referring to FIG. 7, an embodiment of analyzing a video obtained by a video analysis network is described as an example, but it is a matter of course that a video editing device may perform the following embodiment. In this case, the video analysis network may perform analysis on a received video without classifying a reference video and a target video.

More specifically, the video analysis network may classify the received video in units of frames.

In addition, the video analysis network may classify the received video based on a change in a scene. That is, since a video may be bound to a single scene even if there is a difference in the frame number (no.), the video analysis network may analyze that there is a change in the scene based on a frame of the received video.

In addition, the video analysis network may detect and recognize a person appearing on the basis of a frame of the received video. In this case, it is a matter of course that at least one person may be included in one frame. Accordingly, the video analysis network may detect at least one person and determine whether the corresponding person continues to appear according to a change of a frame.

In addition, the video analysis network may detect and recognize an object based on a frame of the received video. At this time, it is a matter of course that at least one object may be included in one frame. Accordingly, the video analysis network may determine what at least one object is. For example, the video analysis network may determine that the object is “food”.

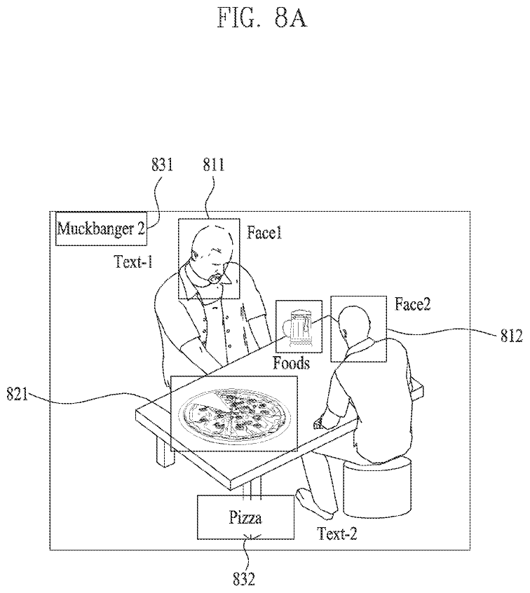

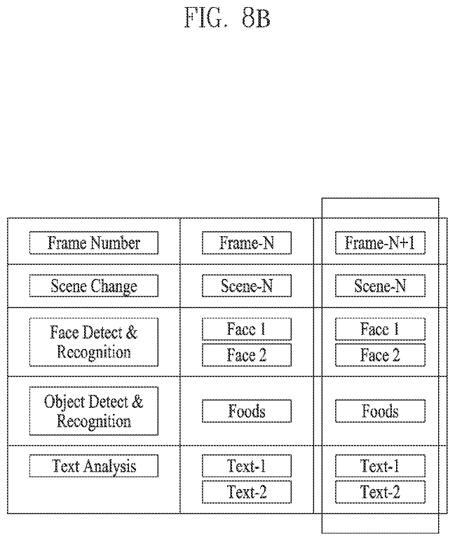

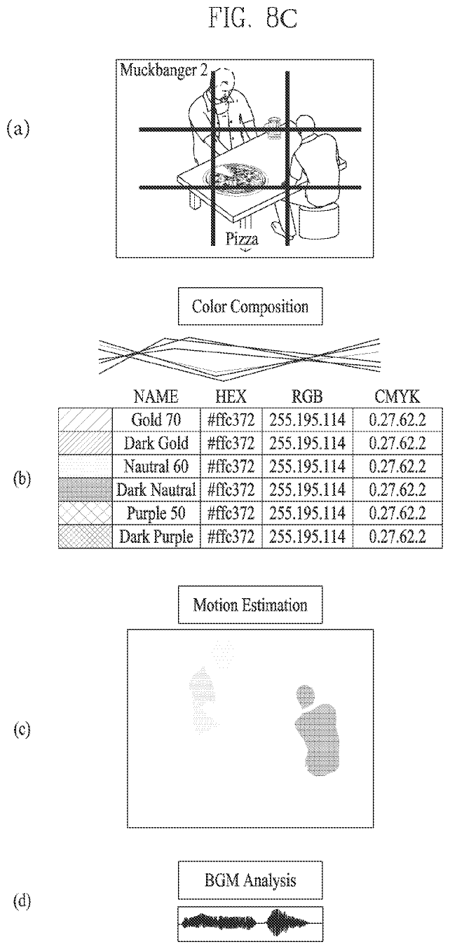

In addition, the video analysis network may analyze text based on a frame of the received video. In this case, at least one text may be included in one frame. Hereinafter, various features that can be analyzed in one frame of a video will be described with reference to FIGS. 8A to 8C.

FIGS. 8A to 8C are diagrams illustrating a detailed example in which a video editing device analyzes a video according to one embodiment of the present disclosure.

FIGS. 8A to 8C are diagrams illustrating an example of analyzing one frame of the video received in FIG. 7.

FIG. 8A illustrates an embodiment in which a video editing device analyzes one frame. Referring to FIG. 8A, a video editing device may perform face recognitions 811 and 812, object recognition 821, and text recognitions 831 and 832 in a single frame based on a single frame of the received video. That is, the video editing device may assign a frame number of the single frame of the received video, and analyze a first face information 811, a second face information 812, a first object information 821, a first text information 831, and a second text information 832, which are recognized in the corresponding frame.

FIG. 8B corresponds to a table showing information analyzed for each frame by the video editing device. Referring to FIG. 8B, the video editing device may store scene change information, face recognition information, object recognition information, and text analysis information, which correspond to each frame.

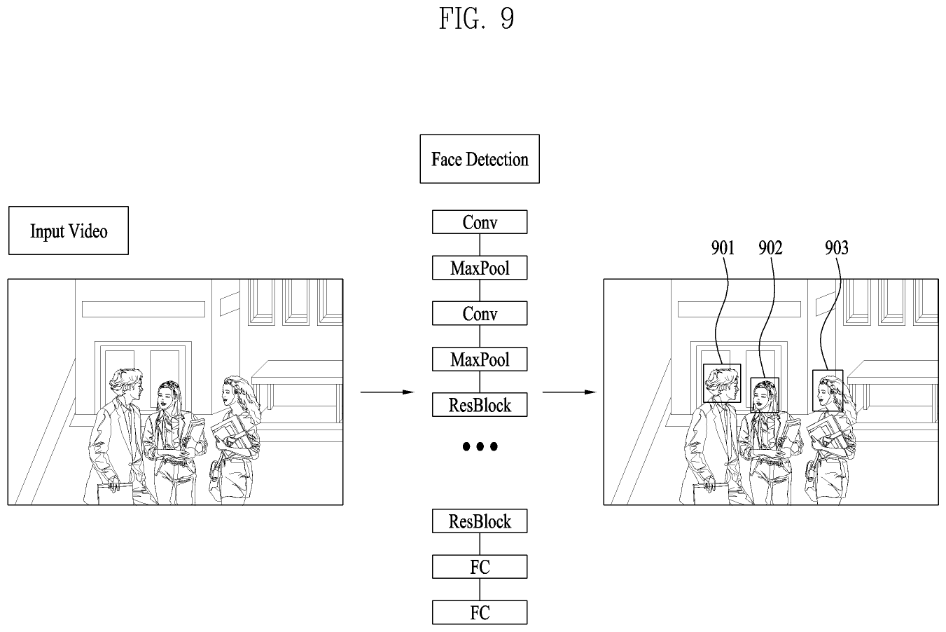

FIG. 8C illustrates another embodiment in which the video editing device analyzes one frame. Referring to FIG. 8C (a), the video editing device may perform video composition with respect to one frame. Referring to FIG. 8C (b), the video editing device may perform color composition with respect to one frame. Referring to FIG. 8C (c), the video editing device may perform motion estimation on one frame. Referring to FIG. 8C (d), the video editing device may perform BGM analysis on one frame. That is, the video editing device may analyze each feature with respect to one frame. Hereinafter, a method of analyzing features will be described in detail with reference to FIGS. 9 to 15. Hereinafter, an analysis of one frame will be described as an example with reference to FIGS. 9 to 15.

FIG. 9 is a diagram illustrating an example of performing face recognition within a video in a video editing device according to one embodiment of the present disclosure.

Referring to the first drawing of FIG. 9, a video editing device may receive a video. The video editing device may use various video analysis algorithms based on a deep learning network for one frame of the received video.

More specifically, referring to the second drawing of FIG. 9, the video editing device may perform face recognition using a plurality of artificial neural networks with respect to a single frame of the received video. For example, the video editing device may perform face recognition on a single frame of the received video through Conv, MaxPool, Resblock, and FC (fully connected network) algorithms. Here, the Conv (Convolutional neural network) includes a weight and bias that can be learned by a convolutional neural network (ConvNet), and may correspond to an artificial neural network having a loss function in a last layer. In addition, the features extracted through the Conv algorithm may reduce the size of data through the MaxPool algorithm. That is, the video editing device may repeatedly recognize a face that can be extracted from a single frame by repeating the Conv algorithm and the MaxPool algorithm. Thereafter, the video editing device may complete the face recognition in an FC layer based on a result extracted by repeatedly performing the Conv algorithm and the MaxPool algorithm in the Conv layer.

Referring to the third drawing of FIG. 9, the video editing device may represent the face recognition informations extracted through the above-described algorithm as indicators 901, 902, and 903 in the video.

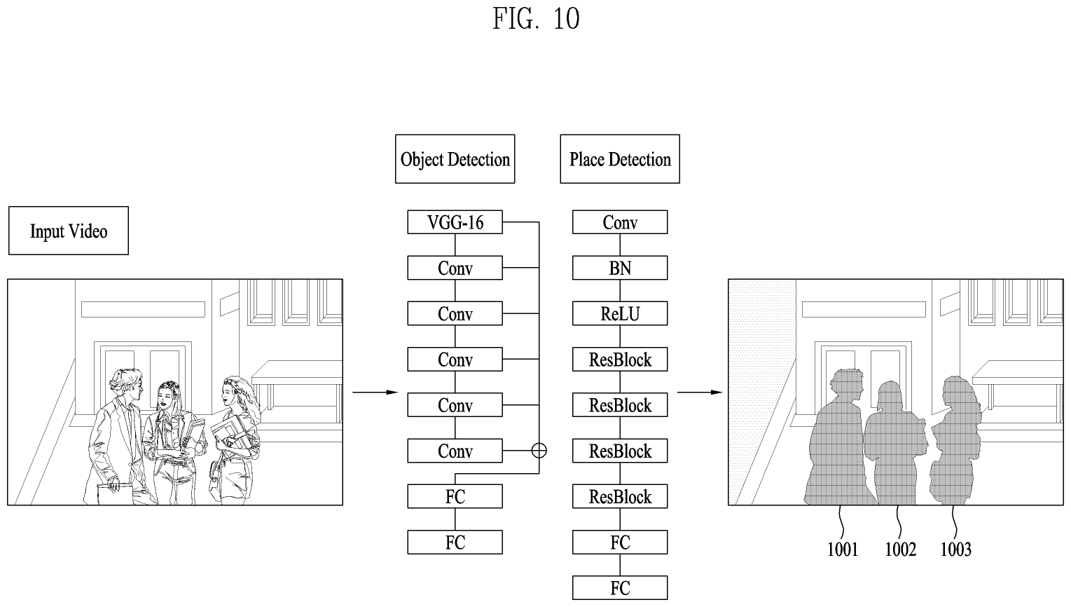

FIG. 10 is a diagram illustrating an example of performing object and place recognition within a video in a video editing device according to one embodiment of the present disclosure.

Referring to the first drawing of FIG. 10, a video editing device may receive a video and use various video analysis algorithms based on a deep learning network for one frame of the received video.

More specifically, referring to the second drawing of FIG. 10, the video editing device may perform object recognition with respect to a single frame of the received video using a plurality of artificial neural networks. For example, the video editing device may perform object recognition on a single frame of the received video through VGG-16 and CONV algorithms. Here, the VGG-16 may correspond to a convolutional neural network composed of 16 layers, and the Conv may be the same as described above. The video editing device may perform object recognition on the received single frame based on the VGG-16 algorithm and a plurality times of the Conv algorithms. Thereafter, the video editing device may complete the object recognition in the FC layer based on a result extracted by repeating the VGG-16 algorithm and the Conv algorithm.

Similarly, the video editing device may perform place recognition with respect to a single frame of the received video using a plurality of artificial neural networks. For example, the video editing device may perform place recognition with respect to a single frame of the received video through Conv, BN, and ReLU algorithms. Thereafter, the video editing device may complete the place recognition in an FC heap layer on the basis of the result extracted by repeating the Conv, BN, and ReLU algorithms. Here, a Batch Normalization (BN) layer adds a standardization layer between a discrimination function and an activation function of all neurons, updates parameters used in a standardization process in a numerical optimization (e.g., a gradient descent method, etc.), and prevents an output of a hidden layer from moving in a specific direction according to the elapse of time.in addition, ReLU corresponds to a function of outputting the input value as it is if an input value is equal to or greater than 0.

Referring to the third drawing of FIG. 10, the video editing device may represent object recognition information and place recognition information extracted through the above-described algorithms as indicators 1001, 1002, and 1003 in the video.

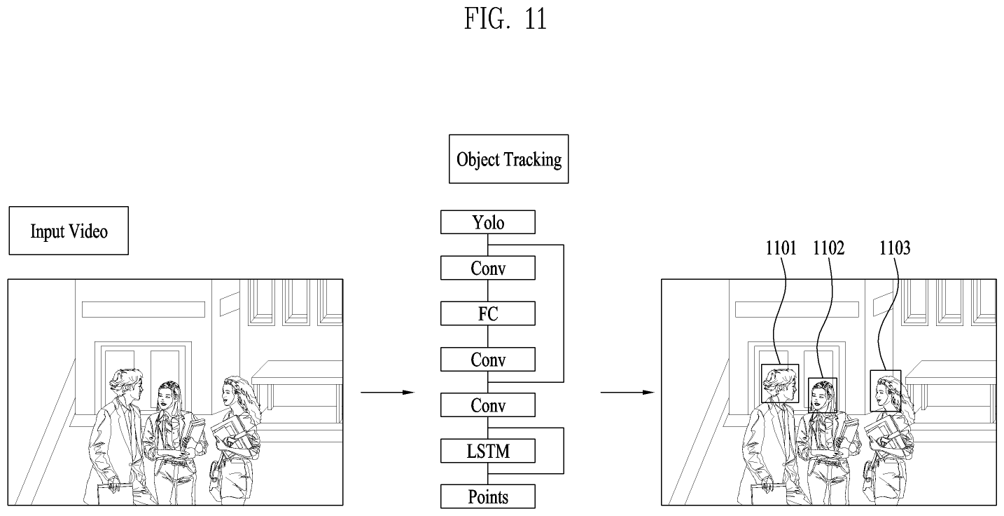

FIG. 11 is a diagram illustrating an example of tracking an object recognized within a video in a video editing device according to one embodiment of the present disclosure.

Referring to the first drawing of FIG. 11, a video editing device may receive a video and use various video analysis algorithms based on a deep learning network for one frame of the received video.

More specifically, referring to the second drawing of FIG. 11, the video editing device may track an object recognized through FIG. 10 using a plurality of artificial neural networks. For example, the video editing device may extract features through a Yolo algorithm and a Conv algorithm with respect to a single frame of the received video. In addition, the video editing device may extract features through the Yolo and Conv algorithms, and then train a model through a Long Short-Term Memory (LSTM). In this case, when the LSTM algorithm and the Conv algorithm are performed together with respect to the extracted features rather than simply performing the Conv algorithm, the performance of the model may be improved. Thereafter, the video editing device may track an object based on the operation result of the model in which the learning is repeated. In this case, in detecting an object, a Yolo operation corresponds to an operation of identifying a final object in a manner of determining a class at a time by dividing an image into a grid and then integrating it.

Referring to the third drawing of FIG. 11, the video editing device may represent object tracking information extracted through the above-described algorithm as indicators 1101, 1102, and 1103 within the video.

In addition, although not shown in the drawings, the video editing device may obtain motion information on a recognized object. For example, the video editing device may determine a static or dynamic motion of the recognized object.

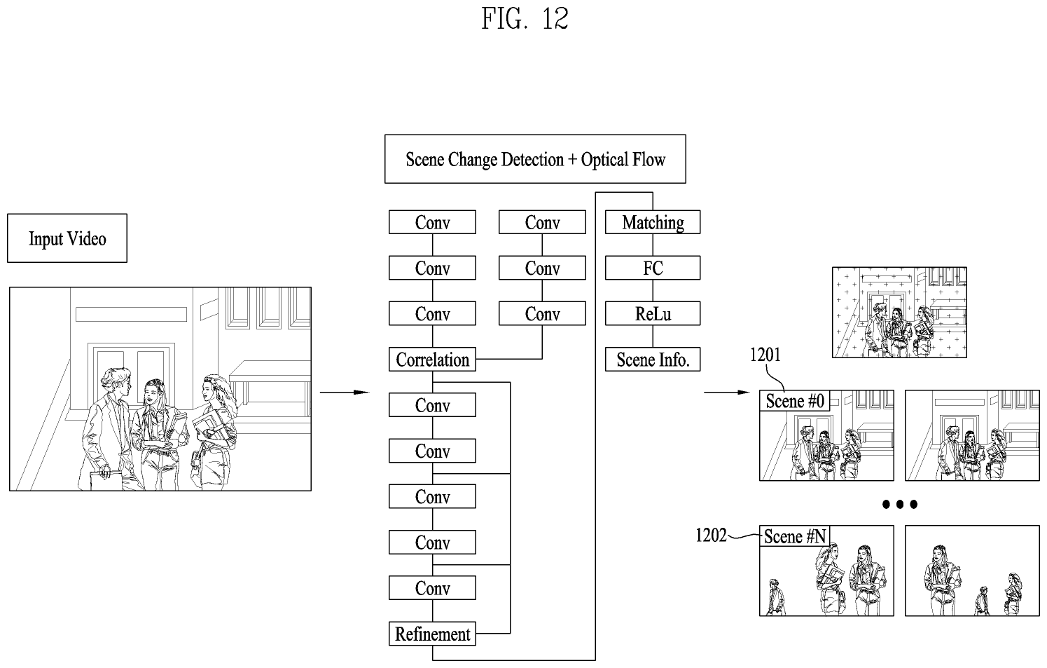

FIG. 12 is a diagram illustrating an example of detecting a scene change within a video in a video editing device according to one embodiment of the present disclosure.

Referring to the first drawing of FIG. 12, a video editing device may receive a video and use various video analysis algorithms based on a deep learning network for one frame of the received video.

More specifically, referring to the second drawing of FIG. 12, the video editing device may detect a scene change by using a plurality of artificial neural networks with respect to a single frame of the received video. For example, the video editing device may detect a scene change through Conv, Correlation, Refinement, Matching, FC, and ReLU algorithms with respect to a single frame of the received video. That is, the video editing device may extract features through a Conv layer with respect to the single frame, and analyze correlation values thereof. Thereafter, the video analysis device may repeat the Cony algorithm and refine the features extracted through the Conv. The video editing device may perform Matching, FC, and ReLU algorithms on the refined features, and may finally extract scene information by refining the performance result once again.

Referring to the third drawing of FIG. 12, the video editing device may represent scene information determined through the above-described algorithms as indicators 1201 and 1202 within the video.

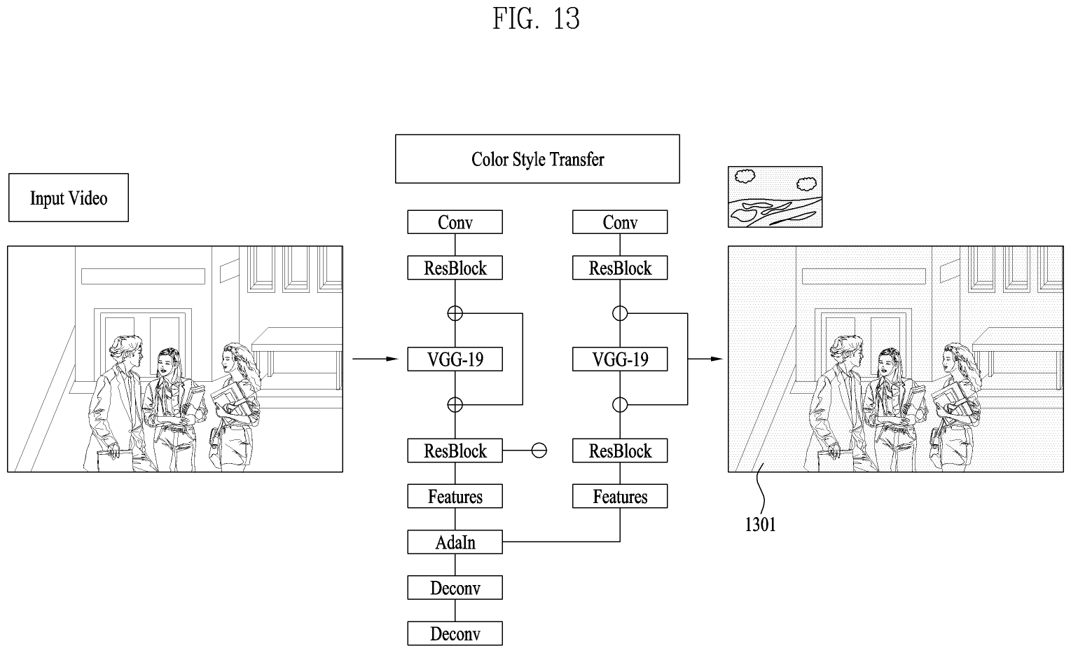

FIG. 13 is a diagram illustrating an example of changing a color style within a video in a video editing device according to one embodiment of the present disclosure.

Referring to the first drawing of FIG. 13, a video editing device may receive a video and use various video analysis algorithms based on a deep learning network for one frame of the received video.

More specifically, referring to the second drawing of FIG. 13, the video editing device may perform color style transfer by using a plurality of artificial neural networks with respect to a single frame of the received video. For example, the video editing device may perform color recognition with respect to a single frame of the received video through Conv, ResBlock, and VGG-19 algorithms. As described above, the VGG-19 may correspond to a convolutional neural network composed of 19 layers. In addition, the video editing device may perform color recognition through a VGG encoder and the like and introduce an Adaptive Instance Normalization (AdaIN) algorithm into a target video.

Referring to the third drawing of FIG. 13, the video editing device may apply the color information extracted through the above-described algorithms to the target video 1301.

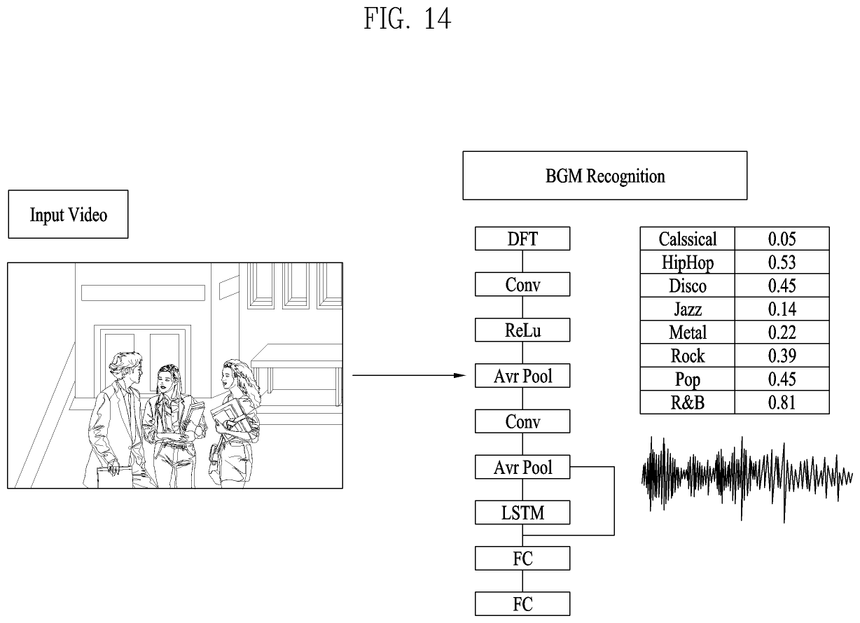

FIG. 14 is a diagram illustrating an example of recognizing a BGM within a video in a video editing device according to one embodiment of the present disclosure.

Referring to the left diagram of FIG. 14, a video editing device may receive a video and use various video analysis algorithms based on a deep learning network for one frame of the received video.

More specifically, referring to the right drawing of FIG. 14, the video editing device may perform BGM recognition using a plurality of artificial neural networks with respect to a single frame of the received video. For example, the video editing device may perform BGM n recognition on a single frame of the received video through DFT, Conv, ReLU, AVr Pool, LSTM, and FC algorithms. Here, a Discrete Fourier Transform (DFT) corresponds to an operation of transforming a spatiotemporal signal into a signal of a frequency domain. In addition, unlike the above description, it is possible to save memory by performing down-sampling at an appropriate level while maintaining features through an Average Pooling algorithm rather than Max pooling. Thereafter, based on the extracted features, the video editing device may complete the BGM recognition in an FC layer. In addition, the video editing device may determine a portion in which BGM fails to appear in a frame.

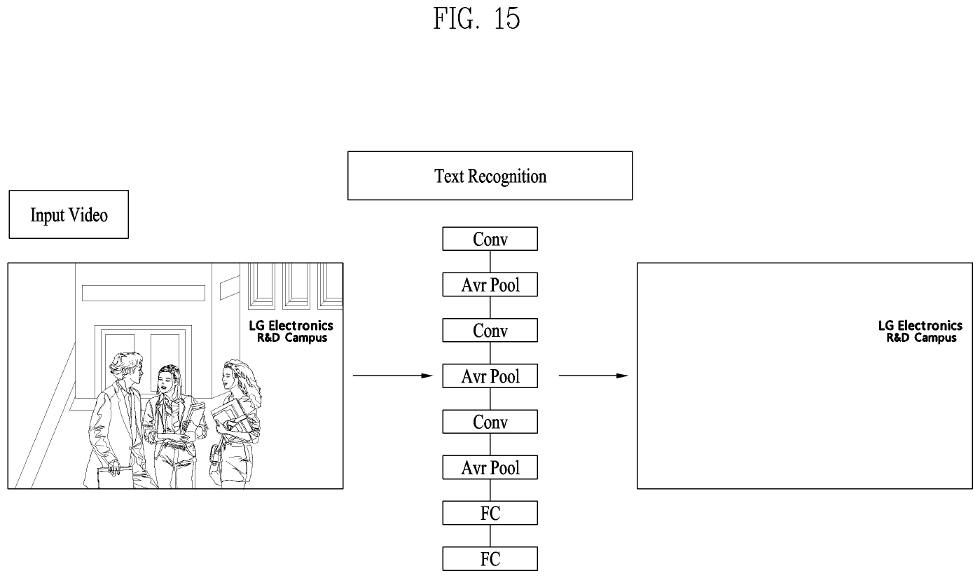

FIG. 15 is a diagram illustrating an example of performing text recognition within a video in a video editing device according to one embodiment of the present disclosure.

Referring to the first drawing of FIG. 15, a video editing device may receive a video and use various video analysis algorithms based on a deep learning network for one frame of the received video.

More specifically, referring to the second drawing of FIG. 15, the video editing device may perform face recognition using a plurality of artificial neural networks with respect to a single frame of the received video. For example, the video editing device may perform text recognition on a single frame of the received video through the Conv and AVR Pool algorithms. Here, the Conv algorithm and the AVR pool algorithm are as described above. In addition, the video editing device may repeatedly perform the Conv algorithm and the AVR pool algorithm to extract samples that are more accurate. The video editing device may complete the text recognition in an FC layer based on features extracted through the Conv algorithm and the AVR pool algorithm.

Referring to the third drawing of FIG. 15, the video editing device may indicate object recognition information and place recognition information extracted through the above-described algorithms using indicators in the video. In this case, the video editing device may determine whether a background of a corresponding frame is outdoor or indoor based on the place recognition information.

That is, the features of the video may be analyzed through the embodiments shown in FIGS. 9 to 15. Hereinafter, a user interface for analyzing and editing a video will be described in detail with reference to FIGS. 16 to 26. In addition, embodiments of automatic/manual editing described in FIGS. 16 to 26 may be performed by video analysis and editing algorithms using the above-described deep learning network.

FIG. 16 is a diagram illustrating an example in which a video editing device obtains a reference video according to one embodiment of the present disclosure.

Referring to FIG. 16, a video editing device may provide a user interface for editing a video to a user. In this case, the video editing device may output the user interface through the display unit described above with reference to FIG. 1.

The video editing device may receive a signal 1601 for adding a reference video. More specifically, the video editing device may output an indicator 1602 indicating addition of a reference video within the user interface for editing the video. The video editing device may add a reference video 1603 based on the user signal 1601 for selecting (e.g. touching the display unit) the indicator 1602 indicating addition of the reference video. In this case, the video editing device may directly add a file corresponding to the reference video 1603 to the video editing user interface based on the user signal 1601. In addition, the video editing device may add the reference video 1603 from a path (URL) corresponding to the reference video 1603 to the video editing user interface based on the user signal 1601. In addition, although not shown in the drawings, the video editing device may provide an example list for the reference video 1603.

In addition, in one embodiment of the present disclosure, after the reference video 1603 is added, the video editing device may change the indicator 1602 indicating the reference video addition into a thumbnail of the reference video 1603.

Hereinafter, an embodiment after the video editing device obtains the reference video will be described with reference to FIG. 17.

FIG. 17 is a diagram illustrating an example of obtaining a target video by a video editing device according to one embodiment of the present disclosure.

Referring to FIG. 17, the video editing device may receive a signal 1701 for adding a target video after obtaining the reference video from the video editing interface described above with reference to FIG. 16. More specifically, the video editing device may output an indicator 1702 indicating addition of a target video in the user interface for editing a video. The video editing device may add a target video 1703 based on the user signal 1701 selecting the indicator 1702 indicating the addition of the target video. In this case, the video editing device may directly add a file corresponding to the target video 1703 to the video editing user interface based on the user signal 1701. In addition, the video editing device may add the target video 1703 from a path (URL) corresponding to the target video 1703 to the video editing user interface based on the user signal 1701. In addition, in one embodiment of the present disclosure, after the target video 1703 is added, the video editing device may change the indicator 1702 indicating the addition of the target video into a thumbnail of the target video 1703.

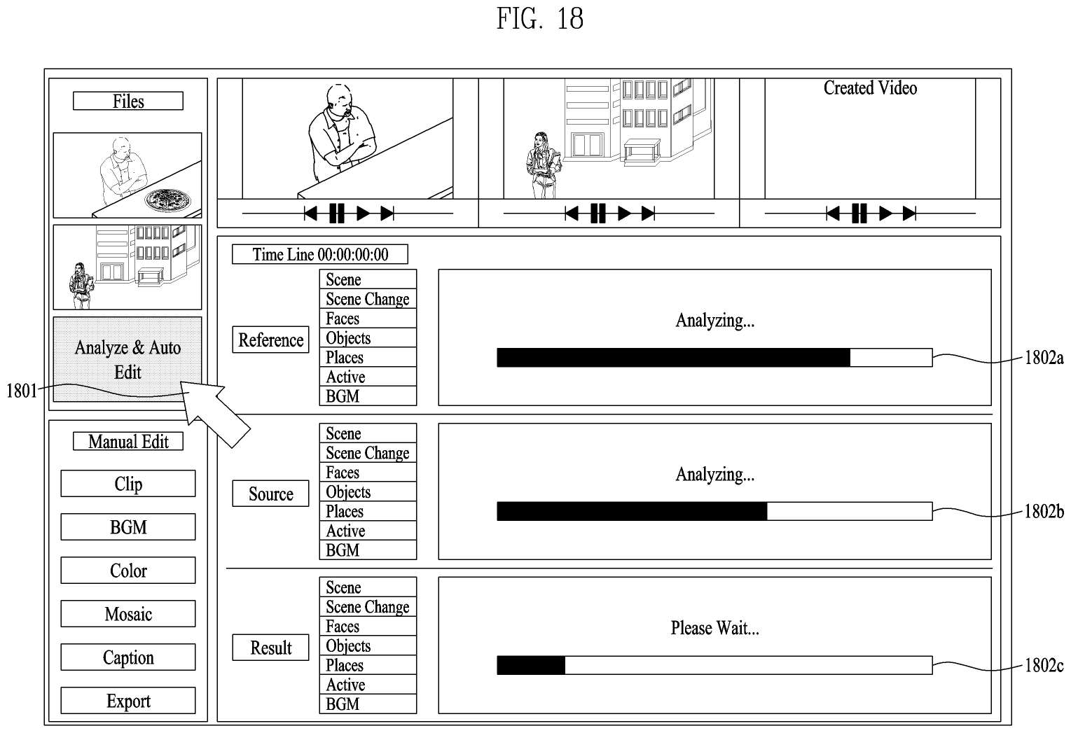

Next, in FIG. 18, an embodiment in which the video editing device obtains both the reference video and the target video will be described.

FIG. 18 is a diagram illustrating an example in which a video editing device analyzes a reference video and a target video according to one embodiment of the present disclosure.

Referring to FIG. 18, the video editing device may receive a signal 1801 for analyzing the reference video and the target video after obtaining the reference video and the target video in the video editing user interface described above with reference to FIG. 16 and FIG. 17.

As the video editing device receives the signal 1801 for analyzing the reference video and the target video, the video editing device may analyze features of the reference video and the target video, respectively, based on the video analysis embodiment described above with reference to FIGS. 7 to 15.

For example, the video editing device may analyze at least one of a scene change effect, a scene change length, a color filter, an angle of view, a composition, a video image quality, a video BGM, a person detection, an object detection, an object classification, a background detection, a place detection, an in-video text, and a subject motion, based on preset frame numbers of the reference video and the target video.

In addition, the video editing device may output a process of analyzing the reference video and the target video to progress bars 1802a, 1802b, and 1802c.

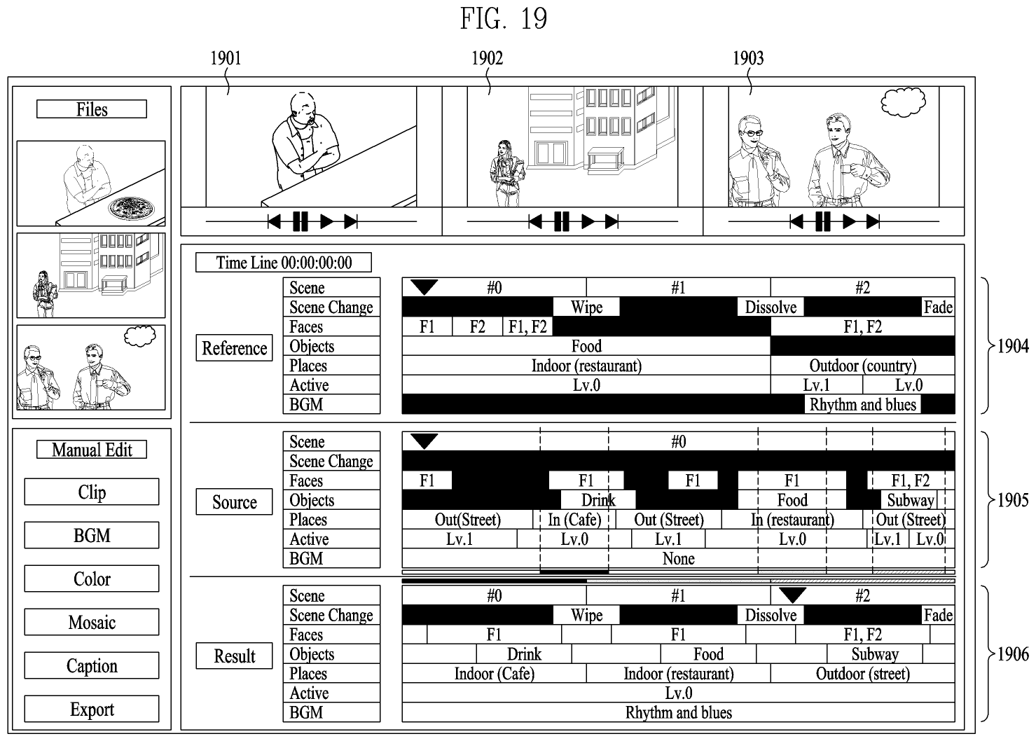

FIG. 19 is a diagram illustrating an embodiment in which a reference video and a target video are analyzed according to one embodiment of the present disclosure.

Referring to FIG. 19, the video editing device may generate a result video 1903 edited by applying the analyzed features of the reference video 1901 to the target video 1902. That is, the video editing device may analyze the features of the reference video 1901 and the target video 1902 through the above-described analysis method, and substitute the features of the reference video 1901 into the features of the target video 1902 based on the analyzed features. Accordingly, the video editing device may output the edited result video 1903. In this case, the video editing device may automatically substitute the features of the reference video 1901 into the features of the target video 1902. This may be the biggest difference from the manual editing described below.

In one embodiment of the present disclosure, the video editing device may output thumbnails corresponding to the reference video 1901, the target video 1902, and the result video 1903, respectively.

In addition, the video editing device may output a first analysis result 1904 of the reference video 1901, a second analysis result 1905 of the target video 1902, and a third analysis result 1906 of the result video 1903. Accordingly, the user may be aware how the features of the reference video 1901, the target video 1902, and the result video 1903 are analyzed through the first analysis result 1904, the second analysis result 1905, and the third analysis result 1906, and how the features of the reference video 1901 are applied to the target video 1902 to output the result video 1903.

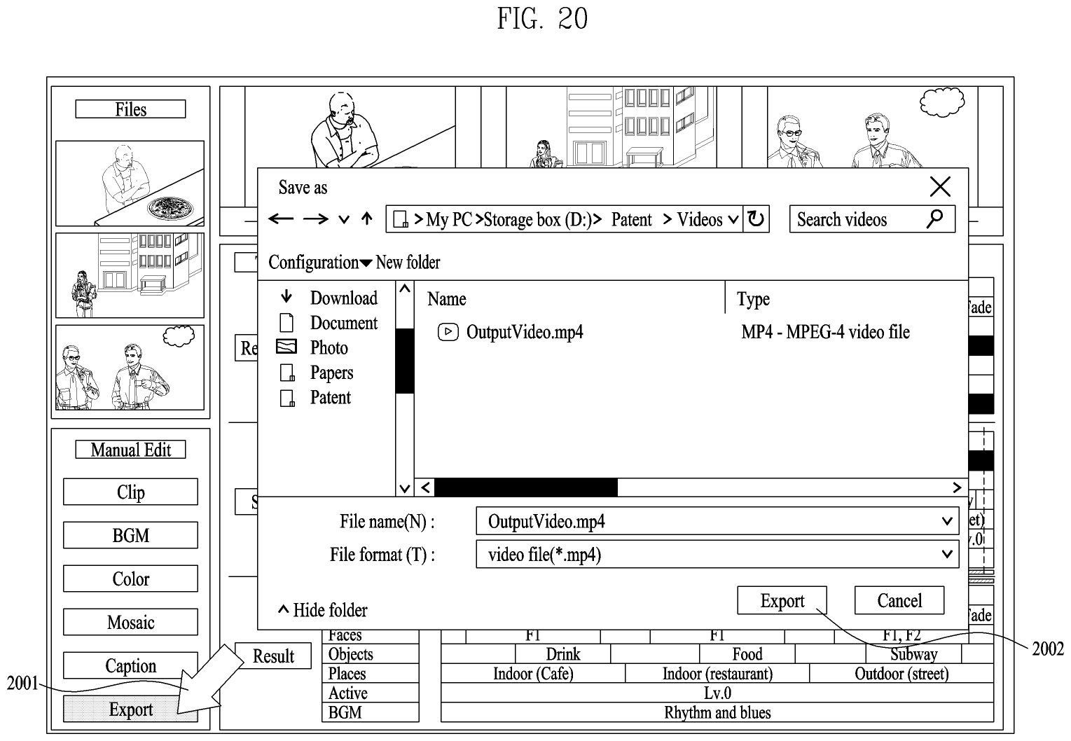

FIG. 20 is a diagram illustrating an example in which a video editing device stores a target video according to one embodiment of the present disclosure.

When the target video is edited based on the features of the reference video according to the above-described embodiments, the video editing device may receive a signal 2001 for requesting to save the result video from the user. The video editing device may output a pop-up window 2002 for saving the result video in response to the reception of the signal 2001 for requesting to save the result video. Accordingly, the video editing device may save the edited video through the pop-up window 2002 as a preset extension.

In addition, although not shown in the drawing, the video editing device may generate a path (URL) capable of outputting the result video upon receiving the signal 2001 requesting to save the result video. That is, the video editing device may save the edited result video to the preset path (URL). Accordingly, the user may view the edited result video through a path (URL) capable of outputting a result video.

In addition, although not shown in the drawing, the video editing device may share the result video through an SNS service as receiving the signal 2001 for requesting to save the result video. In this case, the video editing device may transmit the result video to the outside through the communication unit. That is, the video editing device may provide a list of plurality of SNS services in response to the signal 2001 requesting to save the result video and share the edited result video with the selected SNS service in response to a user's selection.

FIGS. 21 to 26 are diagrams illustrating an embodiment in which a video editing device provides a manual-edit interface according to one embodiment of the present disclosure. The manual-edit interface described in FIGS. 21 to 26 may be executed before or after the automatic editing performed in FIGS. 16 to 20. That is, a user may manually edit a target video through a video editing device at any time.

FIG. 21 is a diagram illustrating an example of clipping a video in a manual-edit interface provided by a video editing device according to one embodiment of the present disclosure.

Referring to FIG. 21, a video editing device may output a first analysis result 2104 of a reference video 2101, a second analysis result 2105 of a target video 2102, and a third analysis result 2106 of an edited result video 2103 through the above-described embodiments.

Thereafter, the video editing device may receive a signal (not shown) for manual editing from a user. Yet, the signal for manual editing is not essential. When the user simply selects a function (for example, a clip function) that enables the user to perform manual editing, the video editing device may recognize it as a signal for manual editing.

In FIG. 21, the video editing device may provide a manual editing function of the target video 2102 in response to a first user input signal 2108 for selecting a clip indicator 2107. Thereafter, the video editing device may additionally edit the target video 2102 based on a second user input signal 2109 for adjusting a length of a scene in the second analysis result 2105 of the target video 2102. Thereafter, the video editing device may additionally generate the result video 2103 by reflecting an additionally edited portion.

That is, through the above-described embodiment, the video editing device may edit the target video 2102 based on the reference video 2101, but may additionally edit the target video 2102 based on the user input signals 2108 and 2109 even after automatically editing the target video 2102.

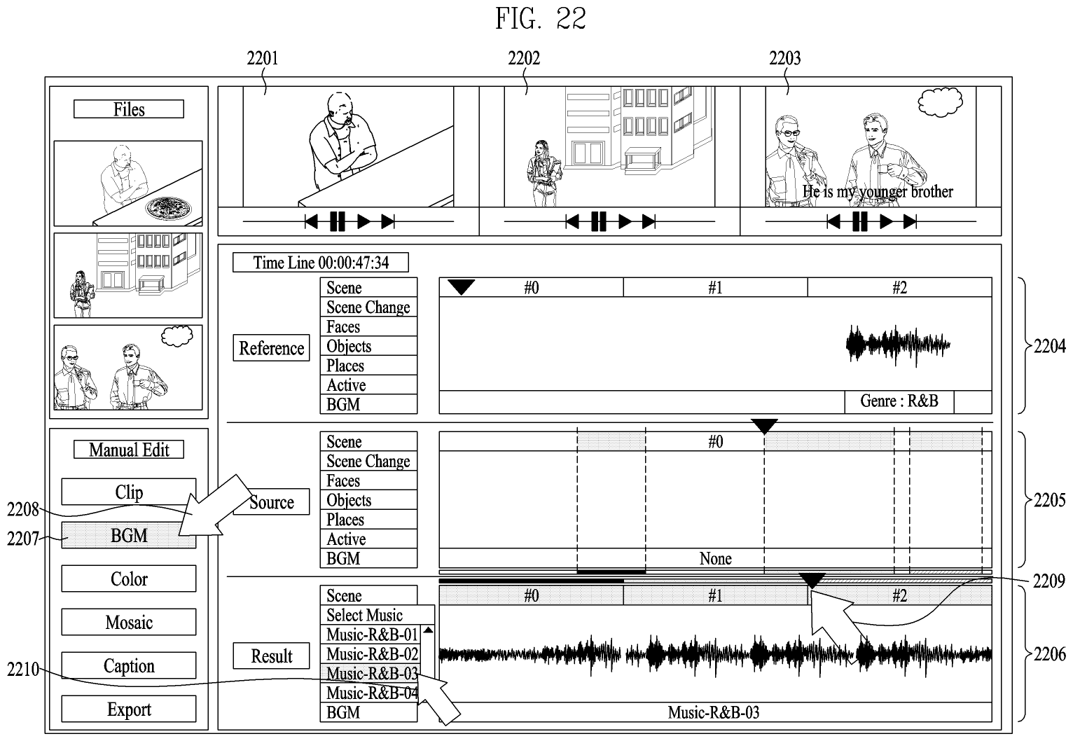

FIG. 22 is a diagram illustrating an example of changing a BGM of a video in a manual-edit interface provided by a video editing device according to one embodiment of the present disclosure.

Referring to FIG. 22, the video editing device may output a first BGM analysis result 2204 of a reference video 2201, a second BGM analysis result 2205 of a target video 2202, and a third BGM analysis result 2206 of an edited result video 2203 through the above-described embodiment.

In this case,, the first BGM analysis result 2204, the second BGM analysis result 2205, and the third BGM analysis result 2206 may be outputted in response to a first user input signal 2208 for selecting a BGM indicator 2207.

More specifically, the video editing device may analyze various features of the reference video 2201, the target video 2202, and the result video 2203 through the above-described embodiment, and output a corresponding analysis result. In this case, the video editing device may preferentially output an analysis result for a function selected by the user. Accordingly, when the user selects the BGM indicator 2207, the video editing device may output the first BGM analysis result 2204 for the reference video 2201, the second BGM analysis result 2205 for the target video 2202, and the third BGM analysis result 2206 for the result video 2203.

Thereafter, the video editing device may receive a second user input signal 2209 for selecting a scene from the user. In addition, after the second user input signal 2209, the video editing device may generate the result video 2203 by changing a BGM of the corresponding scene of the target video 2202 in response to a third user input signal 2210 for selecting the BGM according to the target scene.

More specifically, the video editing device may select the scene of the target video 2202 according to the second user input signal 2209 and may change the BGM scene of the corresponding scene of the target video 2202 according to the third user input signal 2210, based on the outputted first BGM analysis result 2204, the outputted second BGM analysis result 2205, and the outputted third BGM analysis result 2206.

In this case, a BGM list that can be selected by the third user input signal 2210 may be generated based on the first BGM analysis result 2204 and the second BGM analysis result 2205.

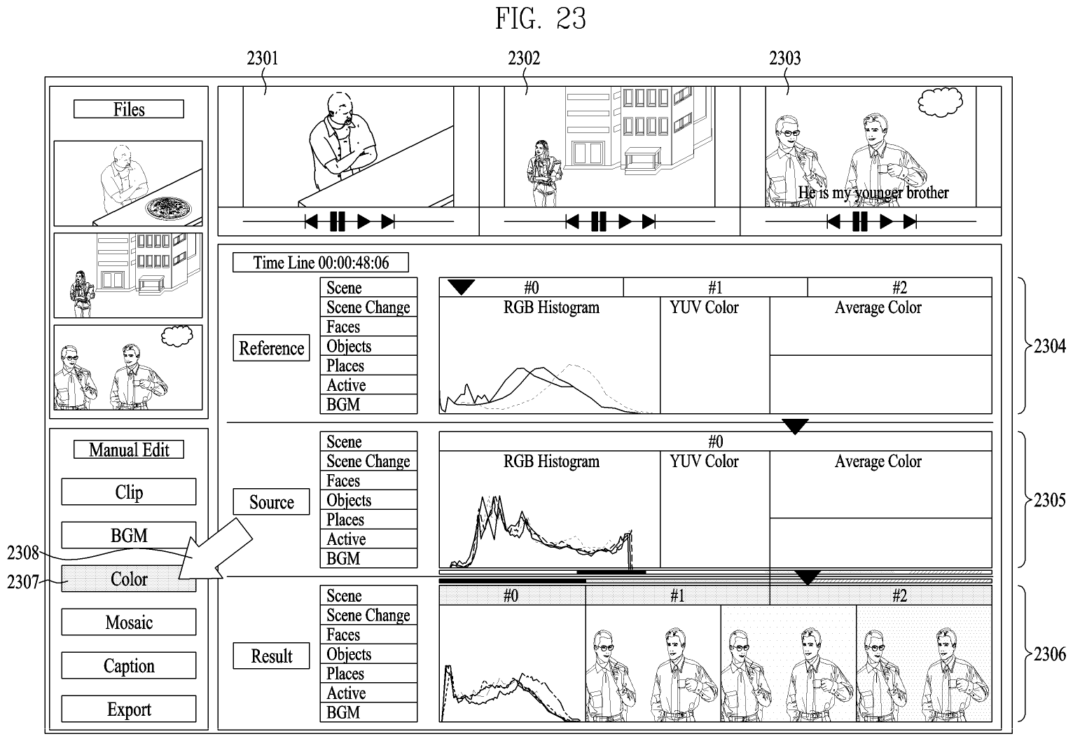

FIG. 23 is a diagram illustrating an example of changing a color of a video in a manual-edit interface provided by a video editing device according to one embodiment of the present disclosure.

Referring to FIG. 23, the video editing device may output a first color analysis result 2304 of a reference video 2301, a second color analysis result 2305 of a target video 2302, and a third color analysis result 2306 of an edited result video 2303 through the above-described embodiment.

In this case, the first color analysis result 2304, the second color analysis result 2305, and the third color analysis result 2306 may be outputted in response to a first user input signal 2308 for selecting a color indicator 2307.

More specifically, the video editing device may analyze various features of the reference video 2301, the target video 2302, and the result video 2303 through the above-described embodiment, and output a corresponding analysis result. In this case, the video editing device may preferentially output an analysis result for a function selected by a user. Accordingly, when the user selects the color indicator 2307, the video editing device may output the first color analysis result 2304 for the reference video 2301, the second color analysis result 2305 for the target video 2302, and the third color analysis result 2306 for the result video 2303.

Thereafter, the video editing device may receive a user input signal (not shown) for selecting a scene from the user. After selecting a scene of the target video 2302, the video editing device may change a color of the scene of the target video 2302 with a color of a scene of the reference video 2301 to be edited. Accordingly, the video editing device may output the result video 2303 in which the color of the corresponding scene is changed.

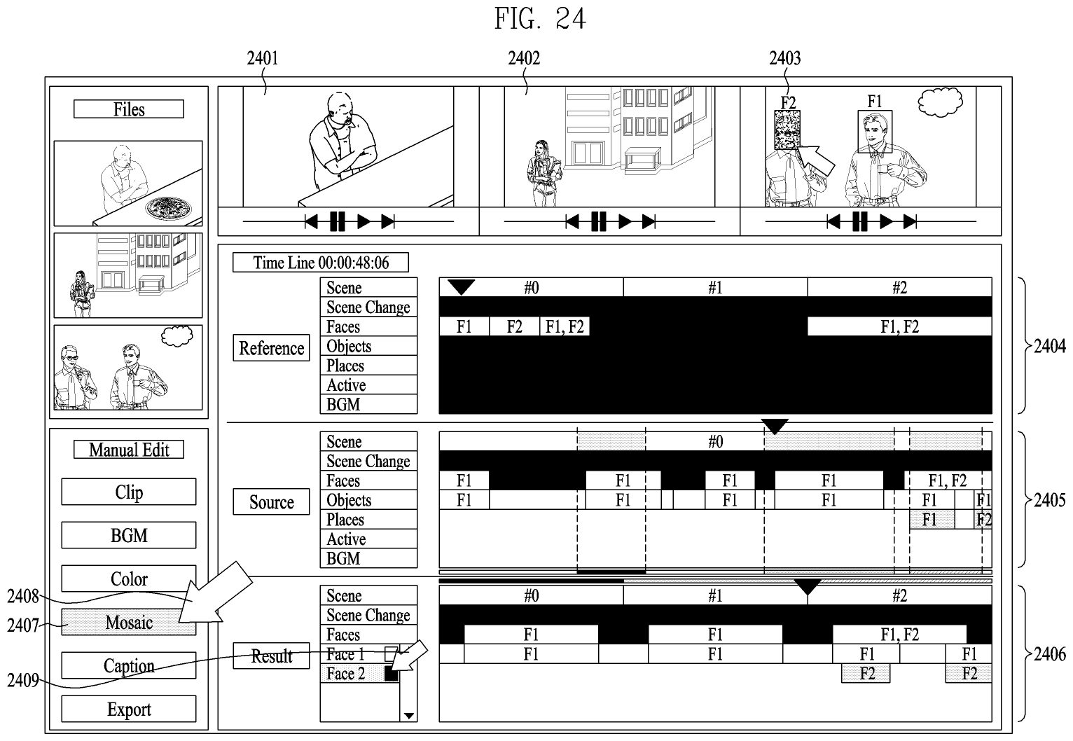

FIG. 24 is a diagram illustrating an example of performing mosaic processing on a video in a manual-edit interface provided by a video editing device according to one embodiment of the present disclosure.

Referring to FIG. 24, the video editing device may output a first face recognition result 2404 of a reference video 2401, a second face recognition result 2405 of a target video 2402, and a third face recognition result 2406 of an edited result video 2403 through the above-described embodiment.

In this case, the first face recognition result 2404, the second face recognition result 2405, and the third face recognition result 2406 may be outputted in response to a first user input signal 2408 for selecting a mosaic processing indicator 2407.

More specifically, the video editing device may analyze various features of the reference video 2401, the target video 2402, and the result video 2403 through the above-described embodiment, and output a corresponding analysis result. In this case, the video editing device may preferentially output an analysis result for a function selected by a user. Accordingly, when the user selects the mosaic process indicator 2407, the video editing device may output the first face recognition result 2404 of the reference video 2401, the second face recognition result 2405 of the target video 2402, and the third face recognition result 2406 of the result video 2403.

In one embodiment of the present disclosure, the video editing device may receive a user input signal 2409 for selecting a second face from the faces to be recognized by the user. Accordingly, the video editing device may mosaic the recognized second face in the target video 2402. Thereafter, the video editing device may save the result video 2403 in which the recognized second face is mosaic-processed only.

In addition, FIG. 24 exemplarily illustrates the embodiment of simply recognizing a face for a person, but is applicable to an embodiment for object recognition.

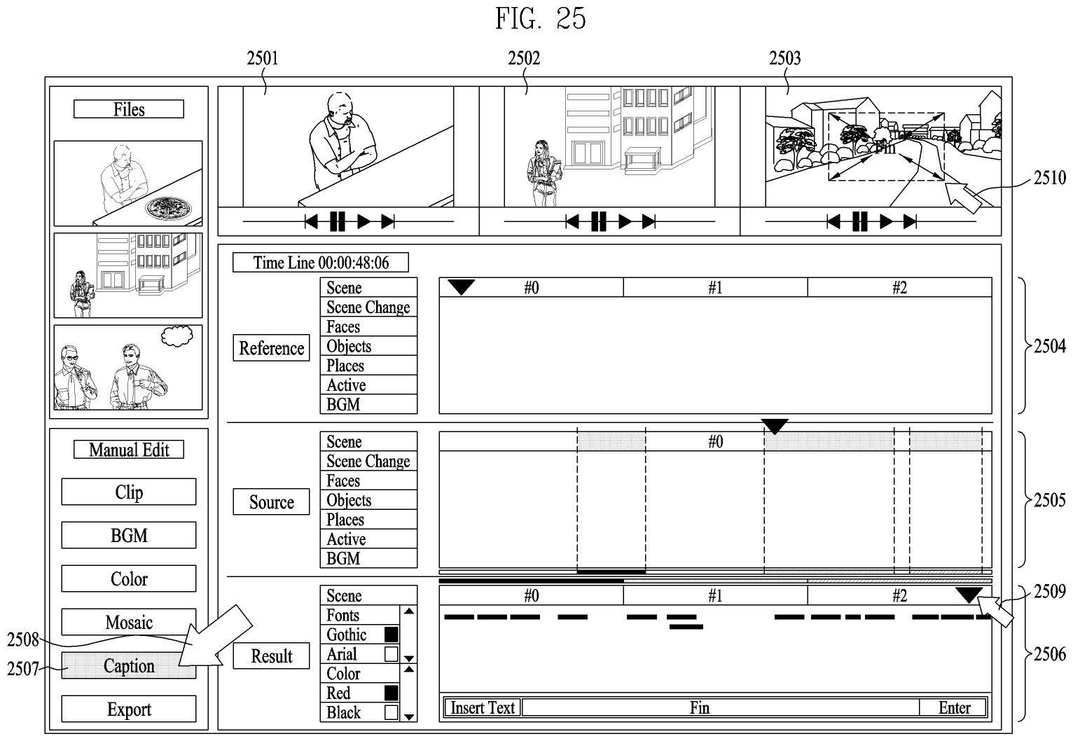

FIG. 25 is a diagram illustrating an example of adding a caption in a manual-edit interface provided by a video editing device according to one embodiment of the present disclosure.

Referring to FIG. 25, the video editing device may output result informations 2504, 2505, and 2506 obtained by analyzing a reference video 2501, a target video 2502, and a result video 2503 based on a scene according to the above-described embodiment. In this case, the video editing device may output the result information 2504, 2505, and 2506 in response to a first user input signal 2508 for selecting a caption addition indicator 2507.

In one embodiment of the present disclosure, the video editing device may receive a second user input signal 2509 for selecting a scene to add a caption to the edited result video 2503 among the analyzed result informations 2504, 2505, and 2506.

In one embodiment of the present disclosure, the video editing device may output an input device (IME) for inputting a caption to be added in response to the second user input signal 2509. The video editing device may output the caption inputted through the input device onto a thumbnail of the result video 2503.

In addition, the video editing device may receive a third user input signal 2510 for adjusting a size of the outputted caption. The video editing device may adjust a size of an added caption based on the third user input signal 2510.

Accordingly, the video editing device may generate the result video 2503 by adding a desired phrase in a scene desired by the user.

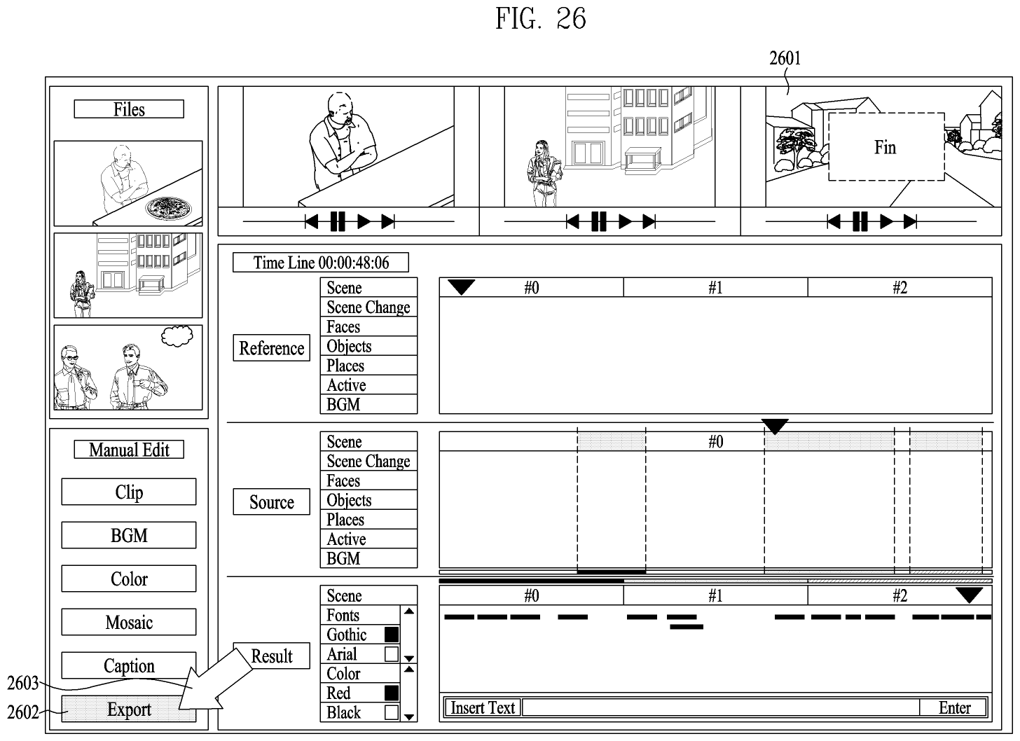

FIG. 26 is a diagram illustrating an example of saving a target video in a manual-edit interface provided by a video editing device according to one embodiment of the present disclosure.

A result video 2601 completed through the manual editing embodiment shown in FIGS. 21 to 25 may be stored based on a user input signal 2603 for selecting a save indicator 2602.

In addition, although the manual editing of FIGS. 21 to 25 is illustrated as being edited in order, it is apparent that the manual editing may be non-limited to the order, but only a specific function may be manually edited in a target video in which automatic editing is completed without performing the manual editing on all functions.

Referring to FIG. 26, the video editing device may save the result video 2601 in which manual editing is completed based on the user input signal 2603 for selecting the save indicator 2602. A detailed embodiment of saving a video may refer to FIG. 20 illustrating the embodiment of saving the automatically edited result video.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The processor may include the controller 180 of the terminal. The foregoing embodiments are merely exemplary and are not to be considered as limiting the present disclosure. The present teachings can be readily applied to other types of methods and apparatuses. This description is intended to be illustrative, and not to limit the scope of the claims. Many alternatives, modifications, and variations will be apparent to those skilled in the art. The features, structures, methods, and other features of the exemplary embodiments described herein may be combined in various ways to obtain additional and/or alternative exemplary embodiments.

### INDUSTRIAL APPLICABILITY

Embodiments of the present disclosure may be repeatedly performed in a video editing device.

What is claimed is:

1. A video editing device, comprising:
a communication unit communicating externally;
an input/output unit receiving a user input and outputting a video editing result; and
a controller configured to obtain a reference video and a target video, analyze features of the obtained reference and target videos, respectively, edit the target video based on the analyzed features of the reference video, and output the edited target video through the input/output unit.

2. The video editing device of claim 1, wherein the analyzed features comprises at least one of a scene change effect, a scene change length, a color filter, an angle of view, a composition, a video quality, a video BGM, a person detection, an object detection, an object classification, a background detection, a place detection, an in-video text, or a subject motion.

3. The video editing device of claim 1, wherein the controller edits the target video based on at least one of a scene change effect, a scene change length, a color style, a motion blur, a resolution, a noise, a BGM, an angle of view, a composition, or a dynamic motion when editing the target video based on the analyzed features of the reference video.

4. The video editing device of claim 1, wherein the controller analyzes the features of the obtained reference video and the features of the obtained target video through a deep learning network, respectively, and edits the target video based on the analyzed features of the reference video.

5. The video editing device of claim 4, wherein the deep learning network comprises a video analysis network and a video editing network and wherein the controller is configured to analyze the features of the obtained reference video and the features of the obtained target video through the video analysis network, respectively, and edit the target video through the video editing network.

6. The video editing device of claim 5, wherein the deep learning network exists in an external server, wherein the video editing device is connected to the deep learning network through the communication unit, and wherein the controller is configured to transmit the obtained reference video and the obtained target video to the deep learning network and receive the edited target video from the deep learning network.

7. The video editing device of claim 1, wherein the controller provides an auto-edit interface to the user.

8. The video editing device of claim 7, wherein the controller is configured to receive inputs of the reference video and the target video from the user, edit the target video according to an editing request of the user, and save the edited target video according to a save request of the user with respect to the edited target video.

9. The video editing device of claim 8, wherein the controller transmits the saved target video externally through the communication unit.

10. The video editing device of claim 8, wherein the controller saves the edited target video to a preset path (URL).

11. The video editing device of claim 1, wherein the controller provides a manual-edit interface to the user with respect to the edited target video when receiving a signal for additional refinement from the user after the edited target video has been outputted.

12. The video editing device of claim 11, wherein the manual-edit interface comprises at least one of a clip, a BGM insertion, a color change, a mosaic processing, or a caption addition.

13. The video editing device of claim 1, wherein the controller receives feedback on the outputted target video from the user.

14. The video editing device of claim 1, further comprising a memory, wherein the controller saves the edited target video to the memory.

15. A method of operating a video editing device, the method comprising:
obtaining a reference video and a target video;
analyzing features of the obtained reference and target videos, respectively;
editing the target video based on the analyzed features of the reference video; and outputting the edited target video.
